(19) United States
(12) Patent Application Publication
(10) Pub. No.: US 2004/0181475 A1
(43) Pub. Date: Sep. 16, 2004

(54) Preferred stock securitization process

(76) Inventor: Ejaz Haroon, Birmingham, AL (US)

Correspondence Address: EJAZ HAROON, 1811 W. GOLF ROAD # 141, MOUNT PROSPECT, IL, 60056, US

(21) Appl. No.: 10/388,941

(22) Filed: Mar. 14, 2003

(51) Int. Cl. G06F 17/60

(52) U.S. Cl. 705/35; 705/36

(57) ABSTRACT

A preferred stock securitization process for conveying at least a portion of any dividends and any redemption proceeds on preferred stock to the holders of newly created securities, for the purpose of providing to these security holders the tax benefits of preferred stock dividends. It creates one or more classes of new securities, with different classes of securities having differing degrees of probability that dividends and redemption proceeds will be received.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of Invention

This securitization process relates to the field of financial securities and, in particular, to the use of securitization for providing federal income tax benefits of preferred stock dividends.

### BACKGROUND

2. Description of Prior Art

Under current tax law dividends on stock investments are taxable to individuals, despite the fact that dividends are generally paid by corporations from after-tax income. On Jan. 7, 2003 the President unveiled the “Growth and Jobs Plan” under which double-taxation of dividends will be eliminated. Under this proposal, any stock dividend that was taxed at the corporate level will be received free of federal income tax by the individual who owns that stock. This treatment will apply to both common stock and preferred stock dividends. The “Growth and Jobs Plan” also envisages increasing the corporate dividends received deduction to 100% of dividends received, which makes dividends free of federal income tax to corporate tax payers as well.

There are only a limited number of investments in the United States that deliver income free of federal income tax to individual investors. Certain municipal bonds, mutual funds that invest in certain municipal bonds, 529 plans for education funding, education IRA's for education funding, and Roth IRA's are the primary ways to obtain income free of federal income tax. Municipal bond investments are usually subject to credit risk and interest rate risk, and the yields on municipal bonds and mutual funds that invest in them are generally lower than those on taxable investments. 529 plans are only available for funding certain types of expenses. Education IRA's and Roth IRA's have limitations in regard to who can invest in them and how much money can be invested in any given year. Additionally, Roth IRA's have limitations on how long the money needs to be invested for it to be withdrawn tax-free.

Prior inventions involving securitization have dealt with securitizing mortgages and mortgage pass throughs, debt securities including corporate bonds, mutual funds, common stock and preferred stock. Specifically:

(a) U.S. Pat. No. 6,070,151 to Frankel (2000) and U.S. Pat. No. 6,460,021 to Kirksey (2002) are regarding securitization of mortgages and mortgage pass throughs, and do not apply to preferred stock securitization.

(b) U.S. Pat. No. 4,739,478 to Roberts et al. (1988) is regarding restructuring debt securities into a serial issue of zero coupon bonds, and does not apply to preferred stock securitization.

(c) U.S. Pat. No. 6,088,685 to Kiron et al. (2000) is regarding securitization of mutual funds, and does not apply to preferred stock securitization.

(d) U.S. Pat. No. 6,381,585 to Maples et al. (2002) deals with joining shares of stock to non-investment bonds, and does not apply to preferred stock securitization.

(e) U.S. Pat. No. 6,330,541 to Meyer et al. (2001) deals with securitization of life insurance policy cash flows, and does not apply to preferred stock securitization.

(f) U.S. patent application Nos. 20030050884 by Barnett, 20020103667 by Jannah et al., 20020095361 by Trenk et al., 20020165809 by Gendelman, 20020055905 by Jannah et al., and 20010042034 by Elliott are regarding securitization of finance receivables, commission payments, promises to make future purchases, oil and gas production streams, reverse mortgage loans, and intellectual properties respectively, and do not apply to preferred stock securitization.

(g) As described in the article “Risk and Valuation of Collateralized Debt Obligations” by Duffie and Garleanu in the January/February 2001 issue of Financial Analysts Journal, debt obligations are currently being securitized in a variety of ways in the United States. As per this article, there are two primary classes of collateralized debt obligations (CDO's) based on the use for which the debt is being securitized, namely “balance sheet” and “arbitrage”. “Balance sheet” CDO's that are designed to remove loans from the balance sheets of banks thereby providing capital relief and increasing liquidity of those assets. “Arbitrage” CDO's are designed to capture some fraction of the difference between the value of the underlying collateral and the value received from management fees and sale of CDO's. This article did not mention preferred stock securitization.

(h) On Aug. 24, 2000, Credit Suisse First Boston managed a $1.3 billion securitization of preferred stock, the first such transaction using CDO criteria. The transaction, named Madison Park, was an “Arbitrage CDO” as defined in (g) above, and was not used to convey federal income tax benefits of preferred stock dividends.

None of these inventions or securitization processes envisage securitization of preferred stock for the purpose of obtaining federal income tax benefits for investors in the newly created securities.

### SUMMARY OF THE INVENTION

This invention provides a tax benefit through a preferred stock securitization process for conveying at least a portion of any dividends and at least a portion of any redemption proceeds on preferred stock to the holders of newly created securities. Depending on the structure of this process, it may create more than one class of new securities.

Preferred stock backing these newly created securities is invested exclusively in a pool of preferred stock, where the corporation that issued preferred stock makes dividend payments on which federal income tax has already been paid. Each class of securities has a stated dividend rate, which is a best-estimate rate of receipt of dividends over the life of that class of securities. At least a portion of dividends received on preferred stock is passed on directly to holders of these securities for a period of time, providing to these holders the income tax advantages of dividends as per the “Growth and Jobs Plan” proposed by the President of the United States in January 2003.

Each class of securities has stated redemptions, which are a best-estimate of the receipt of redemption proceeds over the life of that class of securities.

Dividends and redemption proceeds from the pool of preferred stock, after deducting the issuer's fees and charges, are passed through in varying amounts to these classes of securities, with the result that different classes of securities have differing probabilities of achieving their stated dividend rate and stated redemptions.

The issuer may provide a high degree of probability that the stated dividend rate and stated redemptions will be paid to certain classes of securities, by one or more of the following five mechanisms:

(a) The issuer may issue more than one class of securities, where each successive class is subordinate to the preceding class.

(b) The issuer may back one or more classes of these securities with an additional pool of preferred stock to support the stated dividend rate(s) and stated redemptions.

(c) The issuer may obtain a guarantee from a financial institution regarding the payment of the stated dividend rate(s) and stated redemptions.

(d) The issuer may purchase credit derivatives that at least partly offset any future reduction in dividends and in redemption proceeds from the pool of preferred stock in the event of deterioration in credit worthiness of the preferred stock.

(e) The issuer may purchase options that at least partly offset any future reduction in dividends from the pool of preferred stock in the event that dividend rates decline.

These securities may or may not provide for partial or complete redemption earlier than the stated redemptions.

To facilitate risk management, the investment strategy for the pool of preferred stock will depend on the security's cash flow characteristics and early redemption provisions. The issuer may periodically rebalance the composition of preferred stock in the pool of preferred stock so as to maximize the likelihood that the stated dividend rate is achieved by holders of these securities and that the stated redemptions are made to holders of these securities.

Objects and Advantages:

Accordingly, several objects and advantages of the present invention are:

(a) Due to tax changes proposed under the “Growth and Jobs Plan”, preferred stock dividends paid from after-tax profits will be free of federal income tax to certain taxpayers. When preferred stock dividends are passed through to security holders, the tax advantages of these dividends will also be conveyed to security holders.

(b) Creating different classes of securities, each with a different probability of achieving the stated dividend rate and stated redemptions, allows potential security holders to invest in securities that meet their particular risk and return criteria.

(c) Securities created as a result of this securitization process may be more liquid than the preferred stock in the pool of preferred stock because these securities can be simpler to understand and price than preferred stock.

(d) Granting the security holder and his representatives the right to redeem at least part of the security earlier than its stated redemptions increases the flexibility and utility of the security to the security holder.

(e) Paying an enhanced amount to the security holder in the event that the security holder is confined to a nursing home, becomes disabled, is diagnosed as suffering from a terminal illness or is diagnosed as suffering from a specified critical illness increases the utility of the security to the security holder. Likewise, paying an enhanced amount to the security holder's representative in the event of the security holder's death increases the utility of the security to the security holder's beneficiary.

(f) Illustrating the stated dividend rates of these securities and comparing that to competing investments allows potential security holders to compare various alternatives.

(g) Allowing the security holder to reinvest dividends or redemption proceeds increases the flexibility and utility of the security to the security holder.

(h) Allowing securities to be listed and traded on a secondary market increases their marketability and liquidity.

(i) Obtaining a credit rating on these securities makes it easier for investors to quantify the default risk on these securities, which makes them more marketable and easier to value.

(j) This securitization process will provide the issuer with future revenue through the fees and charges that will be collected.

(k) Under existing tax law, corporations are entitled to a dividends received deduction, so the fees and charges the issuer receives from preferred stock dividends will be eligible for the corporate dividends-received deduction, potentially making it more profitable for the issuer as compared to other types of products.

(l) The issuer may be able to exploit arbitrage opportunities that exist when preferred stock can be bought for the pool of preferred stock at a price that is below its intrinsic value, where intrinsic value is the economic value that future payments from that preferred stock ought to be valued at.

### BRIEF DESCRIPTION OF THE DRAWINGS

FIG. 1 is a flowchart showing the issuance of four classes of securities each with a different probability of receiving dividends and redemption proceeds.

FIGS. 2A, 2B, 2C and 2D are flowcharts showing the issuance of two classes of securities, with variation in the amount of preferred stock that defaults.

FIGS. 3A and 3B are flowcharts showing the issuance of two classes of securities, together with the creation of an additional pool of preferred stock to cover any shortfall in payments on first class of securities.

FIGS. 4A and 4B are flowcharts showing the issuance of two classes of securities, together with the purchase of a guarantee from a financial institution to cover any shortfall in payments on first class of securities.

FIG. 5 is a flowchart showing the issuance of a single class of securities.

FIGS. 6A and 6B are flowcharts showing the issuance of a single class of securities, together with the creation of an additional pool of preferred stock to cover any shortfall in payments.

FIGS. 7A and 7B are flowcharts showing the issuance of a single class of securities, together with the purchase of a guarantee from a financial institution to cover any shortfall in payments.

FIGS. 8A, 8B, 8C and 8D are flowcharts showing the issuance of two classes of securities, together with the right to early redemption.

FIG. 9 is a table that compares the accumulated value of securities created by this invention to alternative investments.

FIG. 10 is a flowchart showing the issuance of two classes of securities, together with the purchase of credit derivatives.

FIG. 11 is a flowchart showing the issuance of two classes of securities, together with the purchase of options.

FIG. 12 is a flowchart showing the issuance of two classes of securities, together with the right to invest additional amounts.

FIGS. 13A and 13B are flowcharts that show the creation of additional classes of securities.

### DETAILED DESCRIPTION OF THE INVENTION

The security-issuing-entity (herein the “issuer”) issues one or more classes of securities purchased by investors (herein the “security holders”). These securities are backed by a pool of preferred stock, and proceeds from the sale of these securities, net of any expenses, are used to purchase preferred stock which is then deposited into the pool of preferred stock. Preferred stock purchased for the pool of preferred stock is such that the corporation that issued the preferred stock makes dividend payments on which federal income tax has already been paid. Each class of security has a best-estimate rate of receipt of dividends over the life of the security (herein the “stated dividend rate”) and has a best-estimate of the receipt of redemption proceeds over the life of the security (herein the “stated redemptions”), but dividends and redemption proceeds from the pool of preferred stock, after deducting the issuer's fees and charges, are passed through in varying amounts to these classes of securities. The result is that each class of security has a different probability of achieving its stated dividend rate and stated redemptions. Within each class of securities, the issuer issues a number of individual securities. Dividends and redemption proceeds from the pool of preferred stock are passed through to these securities for a specified period of years, at the end of which these securities expire.

I have described the invention in the same order that I have laid out my drawings, as follows:

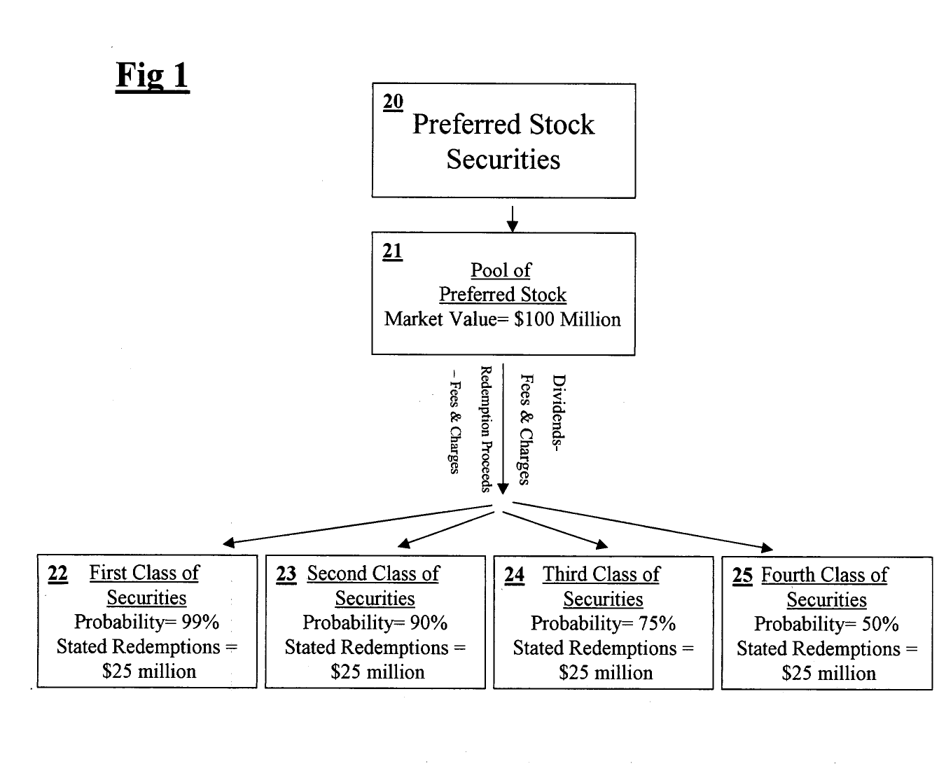

Description of FIG. 1:

FIG. 1 is a flowchart in which the issuer arranges for the issuance of four classes of securities, all of which are backed by a pool of preferred stock 21 of $100 million. Each of these four classes of securities has a stated dividend rate and has stated redemptions, but dividends and redemption proceeds from the pool of preferred stock 21 after deducting the issuer's fees and charges are passed through in varying amounts to these classes of securities, with the result that each class of security has a different probability of achieving its stated dividend rate and stated redemptions. Within each of these four classes of securities, the issuer issues 1,000 securities each with stated redemptions of $25,000. Dividends and redemption proceeds from the pool of preferred stock 21 are passed through to these securities for a period of 10 years, at the end of which these securities expire.

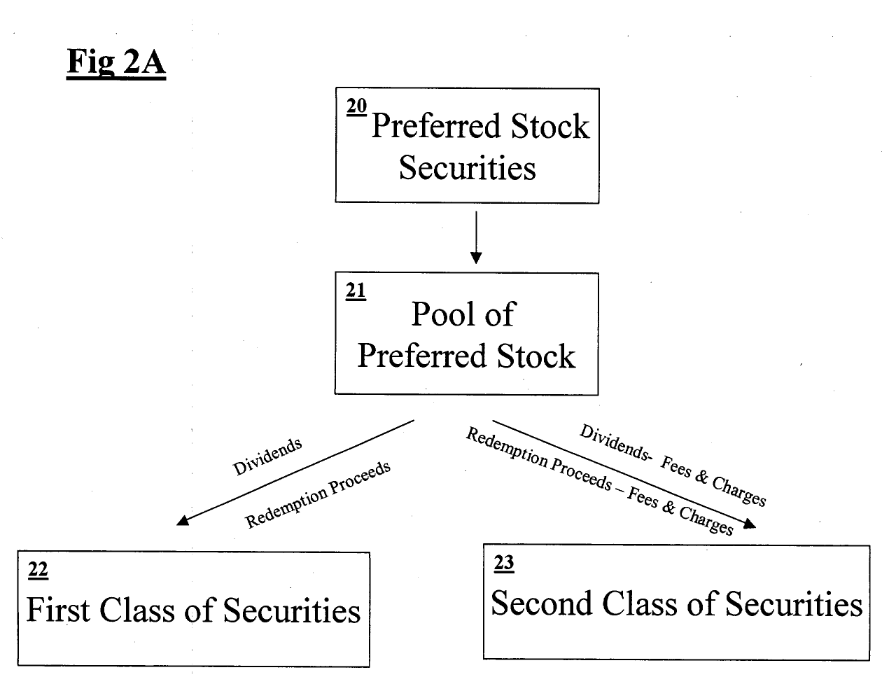

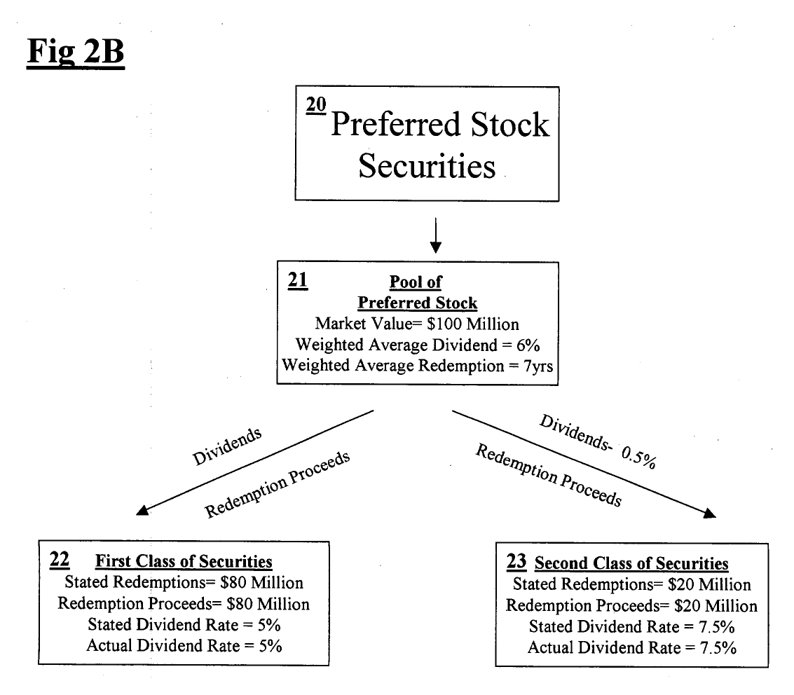

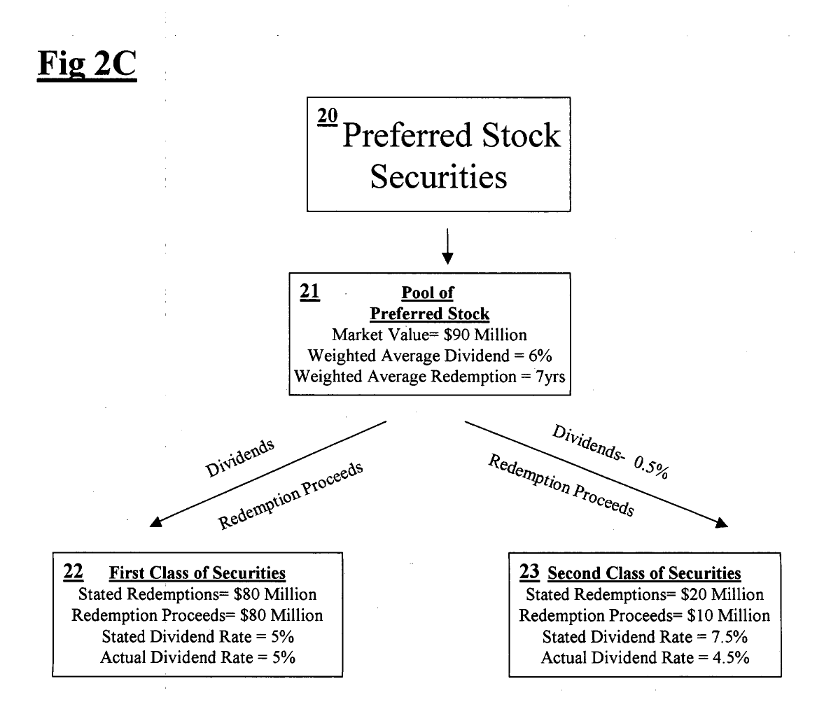

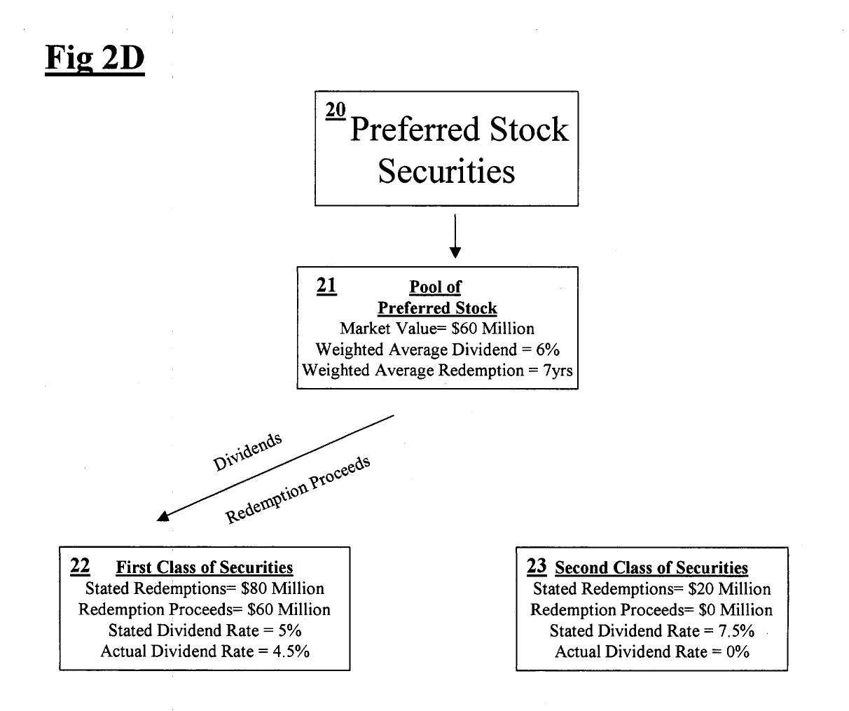

Description of FIGS. 2A, 2B, 2C and 2D:

FIG. 2A is a flowchart in which the issuer arranges for the issuance of two classes of securities: first class of securities 22 and second class of securities 23, both of which are backed by a pool of preferred stock 21. Each class of security has a stated dividend rate and stated redemptions, but the second class of securities 23 is only paid dividends and redemption proceeds after payments have been made on the first class of securities 22 and after the issuer's fees and charges have been paid. In the event that the pool of preferred stock 21 does not generate dividends sufficient to satisfy the dividend rate on both the first and second classes of securities as well as to pay the issuer's fees and charges, the holders of second class of securities 23 will not be paid their stated dividend rate. Similarly, in the event that the pool of preferred stock 21 does not generate redemption proceeds sufficient to satisfy the stated redemptions on both the first and second classes of securities as well as to pay the issuer's fees and charges, the holders of second class of securities 23 will not be paid their stated redemptions. Conversely, in the event that the pool of preferred stock 21 generated dividends that are more than sufficient to satisfy the stated dividend rate on both the first and second classes of securities as well as to pay the issuer's fees and charges, the holders of second class of securities 23 will be paid the excess dividends. Similarly, in the event that the pool of preferred stock 21 generates redemption proceeds that are more than sufficient to satisfy the stated redemptions on both the first and second classes of securities as well as to pay the issuer's fees and charges, the holders of second class of securities 23 will be paid these excess redemption proceeds.

FIG. 2B is a flowchart showing an example of the structure shown in FIG. 2A. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a weighted average dividend of 6% and a weighted average redemption of 7 years. These preferred stock securities 20 are deposited into the pool of preferred stock 21 that backs both the first and second classes of securities. Over the life of the pool of preferred stock 21, the preferred stock securities 20 are assumed to generate annual dividends of 6% and are also assumed to generate redemption proceeds of $100 million. The 6% dividend on the pool of preferred stock 21 is allocated as follows:

1) Used each year to pay the 5% stated dividend rate on first class of securities 22. In the first year, when $80 million of first class of securities 22 are outstanding, this is equal to $4 million

2) Any amount still remaining is used to pay the issuer's fees and charges which are equal to 0.5% of first and second classes of securities outstanding. In the first year, when $80 million of first and $20 million of second class of securities are outstanding, this is equal to $0.5 million

3) Any amount still remaining is used to pay the 7.5% stated dividend rate on second class of securities 23. In the first year, when $20 million of second class of securities 23 are outstanding, this is equal to $1.5 million

4) Any remainder is paid to holders of second class of securities 23. In this example, the entire $6 million has been disbursed at this point, so there is no payment made.

Over the life of the pool of preferred stock 21, the preferred stock securities 20 are assumed to generate redemption proceeds of $100 million, which are allocated as follows:

1) Used to make $80 million of stated redemptions on first class of securities 22.

2) Any amount still remaining is used to repay $20 million of stated redemptions on second class of securities 23.

3) Any remainder is paid to holders of second class of securities 23. In this example, the entire $100 million has been disbursed at this point, so there is no payment made.

FIG. 2C is a flowchart showing another example of the structure shown in FIG. 2A. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a weighted average dividend of 6% and a weighted average redemption of 7 years. These preferred stock securities 20 are deposited into the pool of preferred stock 21 that backs both the first and second classes of securities. Immediately thereafter, $10 million of preferred stock securities 20 are assumed to default and are assumed to pay zero dividends and zero redemption proceeds. The remaining $90 of preferred stock securities 20 are assumed to generate annual dividends of 6% and are also assumed to generate redemption proceeds of $90 million. In the first year dividends on the pool of preferred stock 21 are 6% of the $90 million outstanding preferred stock, or $5.4 million. Dividends are allocated as follows:

1) Used each year to pay the 5% stated dividend rate on first class of securities 22. In the first year, when $80 million of first class of securities 22 are outstanding, this is equal to $4 million

2) Any amount still remaining is used to pay the issuer's fees and charges which are equal to 0.5% of first and second classes of securities outstanding. In the first year, when $80 million of first and $20 million of second class of securities are outstanding, this is equal to $0.5 million

3) Any amount still remaining is used to pay the 7.5% stated dividend rate on second class of securities 23. In the first year, when $20 million of second class of securities 23 are outstanding, this is equal to $1.5 million. However, the dividend amount still remaining at this point is only $0.9 million, so the actual dividend rate paid to holders of second class of securities 23 is $0.9 million divided by $20 million, which equals 4.50%

4) Any remainder is paid to holders of second class of securities 23. In this example, the entire amount has been disbursed at this point, so there is no payment made.

Over the life of the pool of preferred stock 21, the preferred stock securities 20 are assumed to generate redemption proceeds of $90 million, which are allocated as follows:

1) Used to make $80 million of stated redemptions on first class of securities 22.

2) Any amount still remaining is used to make $20 million of stated redemptions on second class of securities 23. However, the redemption proceeds remaining at this point are only $10 million, so the holders of second class of securities 23 only receive half their stated redemptions of $20 million.

3) Any remainder is paid to holders of second class of securities 23. In this example, the entire $90 million has been disbursed at this point, so there is no payment made.

FIG. 2D is a flowchart showing yet another example of the structure shown in FIG. 2A. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a weighted average dividend of 6% and a weighted average redemption of 7 years. These preferred stock securities 20 is deposited into the pool of preferred stock 21 that backs both the first and second classes of securities. Immediately thereafter, $40 million of preferred stock securities 20 are assumed to default and are assumed to pay zero dividends and zero redemption proceeds. The remaining $60 of preferred stock securities 20 are assumed to generate annual dividends of 6% and are also assumed to generate redemption proceeds of $60 million. In the first year dividends on the pool of preferred stock 21 are 6% of the $60 million outstanding preferred stock securities 20, or $3.6 million. Dividends are allocated as follows:

1) Used each year to pay the 5% stated dividend rate on first class of securities 22. In the first year, when $80 million of first class of securities 22 are outstanding, this is equal to $4 million. However, the dividend amount still remaining at this point is only $3.6 million, so the actual dividend rate paid to holders of first class of securities 22 is $3.6 million divided by $80 million, which equals 4.50%

2) Any amount still remaining is used to pay the issuer's fees and charges which are equal to 0.5% of first and second classes of securities outstanding. In the first year, when $80 million of first and $20 million of second class of securities are outstanding, this is equal to $0.5 million. In this example, the entire dividend amount has been disbursed at this point, so there is no payment made.

3) Any amount still remaining is used to pay the 7.5% stated dividend rate on second class of securities 23. In the first year, when $20 million of second class of securities 23 are outstanding, this is equal to $1.5 million. In this example, the entire dividend amount has been disbursed at this point, so there is no payment made.

4) Any remainder is paid to holders of second class of securities 23. In this example, the entire dividend amount has been disbursed at this point, so there is no payment made.

Over the life of the pool of preferred stock 21, the preferred stock securities 20 are assumed to generate redemption proceeds of $60 million, which are allocated as follows:

1) Used to make $80 million of stated redemptions on first class of securities 22. However, the redemption proceeds remaining at this point are only $60 million, so the holders of first class of securities 22 only receive a portion of their stated redemptions, or $60 million.

2) Any amount still remaining is used to make the $20 million of stated redemptions on second class of securities 23. In this example, the entire $60 million has been disbursed at this point, so there is no payment made.

3) Any remainder is paid to holders of second class of securities 23. In this example, the entire $60 million has been disbursed at this point, so there is no payment made.

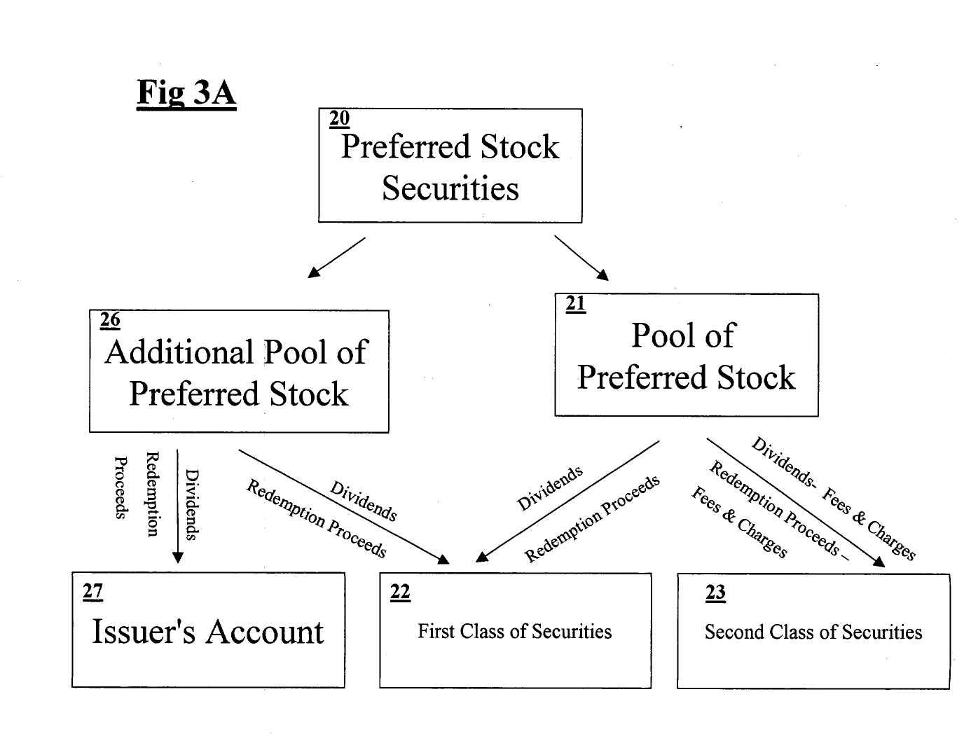

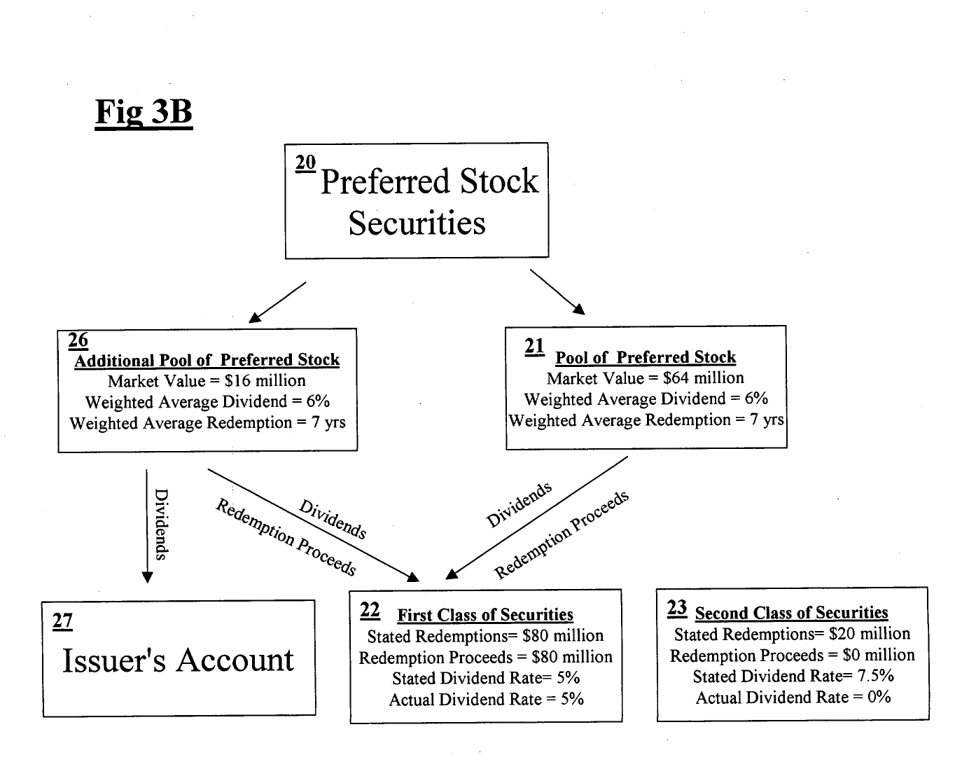

Description of FIGS. 3A and 3B:

FIG. 3A is is a flowchart in which the issuer arranges for the issuance of two classes of securities: first class of securities 22 and second class of securities 23, both of which are backed by a pool of preferred stock 21. Each class of security has a stated dividend rate and stated redemptions, but the second class of securities 23 are only paid dividends and redemption proceeds after payments have been made on the first class of securities 22 and after the issuer's fees and charges have been paid. In the event that the pool of preferred stock 21 does not generate dividends sufficient to satisfy the dividend rate on both the first and second classes of securities as well as to pay the issuer's fees and charges, the holders of second class of securities 23 will not be paid their stated dividend rate. Similarly, in the event that the pool of preferred stock 21 does not generate redemption proceeds sufficient to satisfy the stated redemptions on both the first and second classes of securities as well as to pay the issuer's fees and charges, the holders of second class of securities 23 will not be paid their stated redemptions. Conversely, in the event that the pool of preferred stock 21 generated dividends that are more than sufficient to satisfy the stated dividend rate on both the first and second classes of securities as well as to pay the issuer's fees and charges, the holders of second class of securities 23 will be paid the excess dividends. Similarly, in the event that the pool of preferred stock 21 generates redemptions that are more than sufficient to satisfy the stated redemptions on both the first and second classes of securities as well as to pay the issuer's fees and charges, the holders of second class of securities 23 will be paid these excess redemptions. In the event that the pool of preferred stock 21 does not generate dividends sufficient to satisfy the dividend rate on first class of securities 22, or generate redemptions sufficient to satisfy the stated redemptions on first class of securities 22, the issuer will set up an additional pool of preferred stock 26 and purchase preferred stock securities 20 for this additional pool of preferred stock 26 in an amount sufficient to overcome these shortfalls in dividends and in redemption proceeds. Any proceeds from preferred stock securities 20 in the additional pool of preferred stock 26 that remain after covering these shortfalls will belong to the issuer's account 27 and will be passed through to the issuer's account 27.

FIG. 3B is a flowchart showing an example of the structure that I have shown in FIG. 3A. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a weighted average dividend of 6% and a weighted average redemption of 7 years. These preferred stock securities 20 are deposited into the pool of preferred stock 21 that backs both the first and second classes of securities. Immediately thereafter, $36 million of preferred stock securities 20 are assumed to default and are assumed to pay zero dividends and zero redemption proceeds. The remaining $64 million of preferred stock securities 20 are assumed to generate annual dividends of 6% and are also assumed to generate redemption proceeds of $64 million. To cover any shortfall in the stated dividend rate or stated redemptions on first class of securities 22, the issuer sets up an additional pool of preferred stock 26 and purchases $16 million of preferred stock securities 20 with a weighted average dividend of 6% and weighted average redemption of 7 years. In the first year dividends on the pool of preferred stock 21 are 6% of the $64 million outstanding preferred stock securities 20, or $3.84 million. In the first year dividends on the additional pool of preferred stock 26 are 6% of the $16 million outstanding preferred stock securities 20, or $0.96 million. Dividends are allocated as follows:

1) Used each year to pay the 5% stated dividend rate on first class of securities 22. In the first year, when $80 million of first class of securities 22 are outstanding, this is equal to $4 million. However, the dividend amount from the pool of preferred stock 21 still remaining at this point is only $3.84 million, so the issuer covers the shortfall by passing through $0.16 of dividends from the additional pool of preferred stock 26.

2) Any amount still remaining is used to pay the issuer's fees and charges which are equal to 0.5% of first and second classes of securities outstanding. In the first year, when $80 million of first and $20 million of second class of securities are outstanding, this is equal to $0.5 million. In this example, the entire dividends from the pool of preferred stock 21 have been disbursed at this point, so there is no payment made from the pool of preferred stock 21, and the remaining dividends from the additional pool of preferred stock 26 ($0.80 million in the first year) are passed through to the issuer's account 27.

3) Any amount still remaining from the pool of preferred stock 21 is used to pay the 7.5% stated dividend rate on second class of securities. In the first year, when $20 million of second class of securities 23 are outstanding, this is equal to $1.5 million. In this example, the entire dividend amount has been disbursed at this point, so there is no payment made.

4) Any remainder from the pool of preferred stock 21 is paid to holders of second class of securities 23. In this example, the entire dividend amount has been disbursed at this point, so there is no payment made.

Over the life of the pool of preferred stock 21, the pool of preferred stock 21 is assumed to generate redemption proceeds of $64 million, and the additional pool of preferred stock 26 is assumed to generate redemption proceeds of $16 million, which are allocated as follows:

1) Used to make $80 million of stated redemptions on first class of securities 22. However, the redemption proceeds from the pool of preferred stock 21 remaining at this point are only $64 million, so the issuer covers the shortfall by passing through the entire $16 million of redemption proceeds from the additional pool of preferred stock 26.

2) Any amount still remaining from the pool of preferred stock 21 is used to make $20 million of stated redemptions on second class of securities 23. In this example, the entire $64 million has been disbursed at this point, so there is no payment made.

3) Any remainder from the pool of preferred stock 21 is paid to holders of second class of securities 23. In this example, the entire $64 million has been disbursed at this point, so there is no payment made.

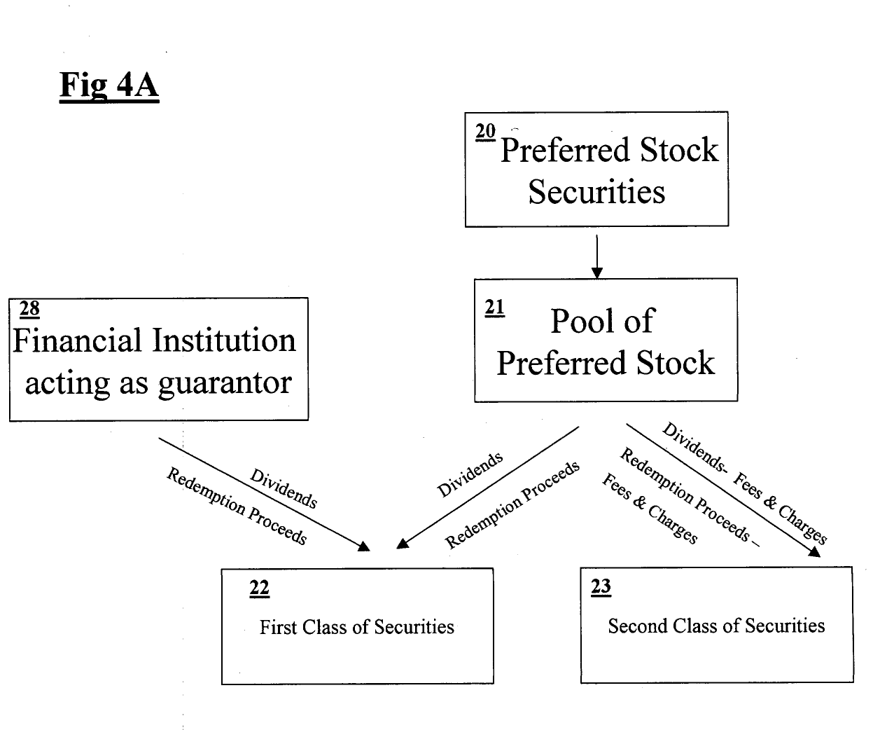

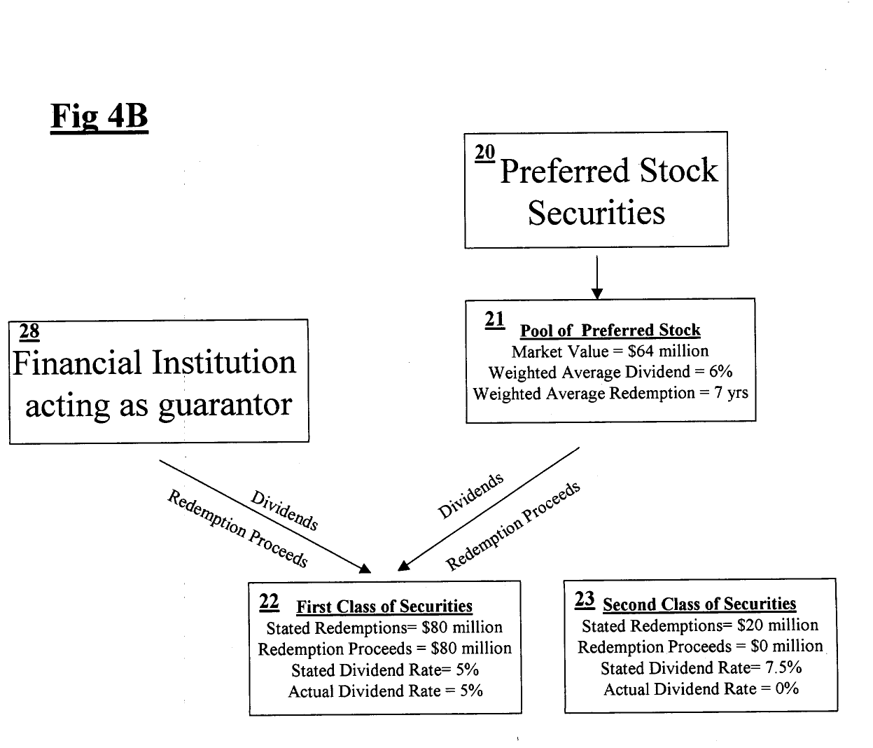

Description of FIGS. 4A and 4B:

FIG. 4A is a flowchart in which the issuer arranges for the issuance of two classes of securities: first class of securities 22 and second class of securities 23, both of which are backed by a pool of preferred stock 21. Each class of security has a stated dividend rate and stated redemptions, but the second class of securities 23 are only paid dividends and redemption proceeds after payments have been made on the first class of securities 22 and after the issuer's fees and charges have been paid. In the event that the pool of preferred stock 21 does not generate dividends sufficient to satisfy the dividend rate on both the first and second classes of securities as well as to pay the issuer's fees and charges, the holders of second class of securities 23 will not be paid their stated dividend rate. Similarly, in the event that the pool of preferred stock 21 does not generate redemption proceeds sufficient to satisfy the stated redemptions on both the first and second classes of securities as well as to pay the issuer's fees and charges, the holders of second class of securities 23 will not be paid their stated redemptions. Conversely, in the event that the pool of preferred stock 21 generated dividends that are more than sufficient to satisfy the stated dividend rate on both the first and second classes of securities as well as to pay the issuer's fees and charges, the holders of second class of securities 23 will be paid the excess dividends. Similarly, in the event that the pool of preferred stock 21 generates redemption proceeds that are more than sufficient to satisfy the stated redemptions on both the first and second classes of securities as well as to pay the issuer's fees and charges, the holders of second class of securities 23 will be paid these excess redemption proceeds. Additionally the issuer arranges for and purchases a guarantee from a financial institution 28 that in the event the pool of preferred stock 21 does not generate dividends sufficient to satisfy the stated dividend rate on the first class of securities 22, or generate redemption proceeds sufficient to satisfy the stated redemptions on the first class of securities 22, the financial institution 28 will pass through payments of preferred stock dividends and preferred stock redemption proceeds to holders of the first class of securities 22 in an amount sufficient to overcome any shortfall.

FIG. 4B is a flowchart showing an example of the structure that I have shown in FIG. 4A. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a weighted average dividend of 6% and a weighted average redemption of 7 years. These preferred stock securities 20 are deposited into the pool of preferred stock 21 that backs both the first and second classes of securities. To cover any shortfall in the stated dividend rate or stated redemptions on first class of securities 22, the issuer has purchased a guarantee from a financial institution 28 under which the financial institution 28 will pass through preferred stock securities dividends and redemption proceeds sufficient to cover the shortfall. Immediately thereafter, $36 million of preferred stock securities 20 are assumed to default and are assumed to pay zero dividends and zero redemption proceeds. The remaining $64 million of preferred stock securities 20 are assumed to generate annual dividends of 6% and are also assumed to generate redemption proceeds of $64 million. To cover any shortfall of dividends or redemption proceeds to holders of first class of securities 22, the financial institution 28 that serves as guarantor passes through any shortfall that arises because of this default. In the first year dividends on the pool of preferred stock 21 are 6% of the $64 million outstanding preferred stock securities 20, or $3.84 million. Dividends are allocated as follows:

1) Used each year to pay the 5% stated dividend rate on first class of securities 22. In the first year, when $80 million of first class of securities 22 are outstanding, this is equal to $4 million. However, the dividend amount from the pool of preferred stock 21 still remaining at this point is only $3.84 million, so the financial institution 28 that serves as guarantor covers the shortfall by passing through $0.16 of dividends from preferred stock securities that it owns.

2) Any amount still remaining is used to pay the issuer's fees and charges which are equal to 0.5% of first and second classes of securities outstanding. In the first year, when $80 million of first and $20 million of second class of securities are outstanding, this is equal to $0.5 million. In this example, the entire dividend amount from the pool of preferred stock 21 has been disbursed at this point, so there is no payment made.

3) Any amount still remaining from the pool of preferred stock 21 is used to pay the 7.5% stated dividend rate on second class of securities 23. In the first year, when $20 million of second class of securities 23 are outstanding, this is equal to $1.5 million. In this example, the entire dividend amount has been disbursed at this point, so there is no payment made.

4) Any remainder from the pool of preferred stock 21 is paid to holders of second class of securities 23. In this example, the entire dividend amount has been disbursed at this point, so there is no payment made.

Over the life of the pool of preferred stock 21, the pool of preferred stock 21 is assumed to generate redemption proceeds of $64 million, which are allocated as follows:

1) Used to make $80 million of stated redemptions on first class of securities 22. However, the redemption proceeds from the pool of preferred stock 21 remaining at this point are only $64 million, so the financial institution 28 that serves as guarantor passes through $16 million of redemption proceeds from preferred stock securities that it owns to make up for this shortfall.

2) Any amount still remaining from the pool of preferred stock 21 is used to make $20 million of stated redemptions on second class of securities 23. In this example, the entire $64 million has been disbursed at this point, so there is no payment made.

3) Any remainder from the pool of preferred stock 21 is paid to holders of second class of securities 23. In this example, the entire $64 million has been disbursed at this point, so there is no payment made.

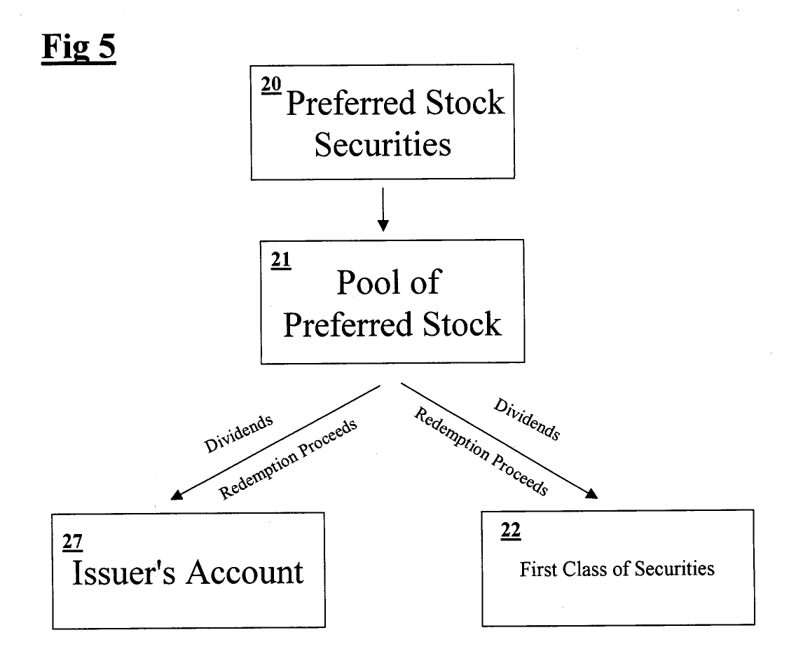

Description of FIG. 5:

FIG. 5 is a flowchart in which the issuer arranges for the issuance of a single class of securities termed first class of securities 22, which is backed by a pool of preferred stock 21. This first class of securities 22 has a stated dividend rate and has stated redemptions. Dividends from the pool of preferred stock 21 are passed through to the holders of these securities to the extent that dividends do not exceed the stated dividend rate, and any redemption proceeds from that pool of preferred stock 21 are passed through to the holders of these securities to the extent that redemption proceeds do not exceed the stated redemptions. Any amounts not passed through to security holders will belong to the issuer's account 27 and will be passed through to the issuer's account 27.

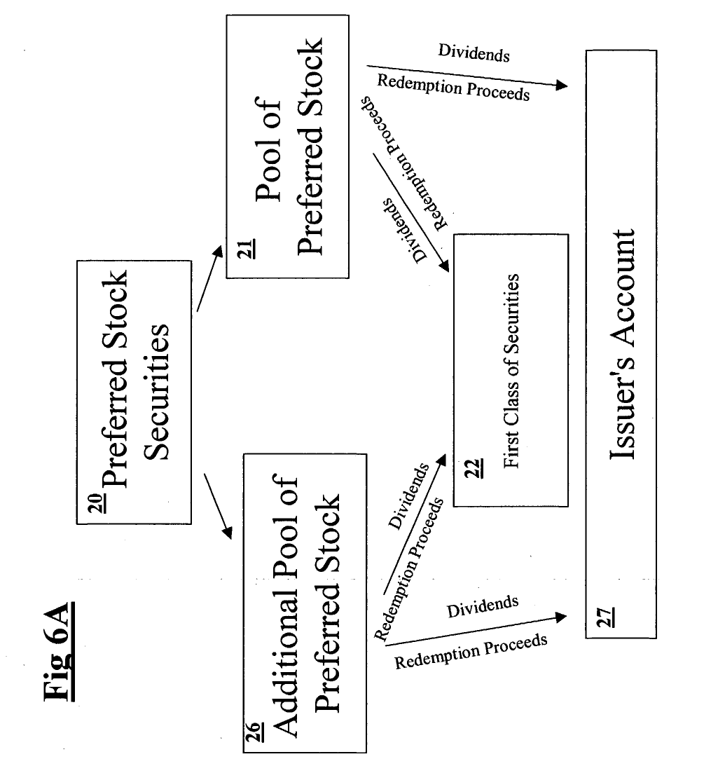

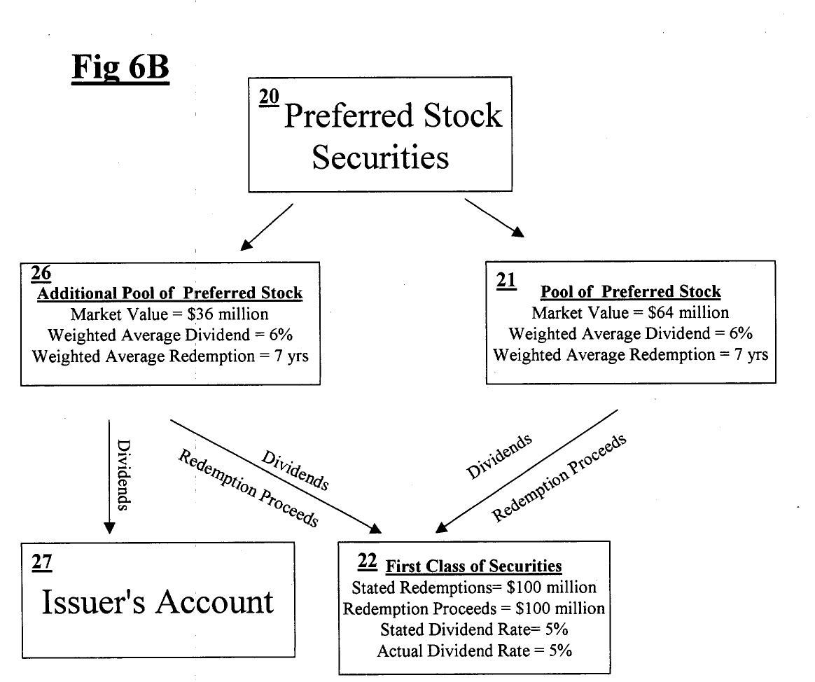

Description of FIGS. 6A and 6B:

FIG. 6A is a flowchart in which the issuer arranges for the issuance of a single class of securities termed first class of securities 22, which is backed by a pool of preferred stock 21. This first class of securities 22 has a stated dividend rate and stated redemptions. Dividends from the pool of preferred stock 21 are passed through to the holders of these securities to the extent that dividends do not exceed the stated dividend rate, and any redemption proceeds from that pool of preferred stock 21 are passed through to the holders of these securities to the extent that redemption proceeds do not exceed the stated redemptions. Any amounts not passed through to security holders will belong to the issuer's account 27 and will be passed through to the issuer's account 27. In the event that the pool of preferred stock 21 does not generate dividends sufficient to satisfy the dividend rate on first class of securities 22, or generate redemptions sufficient to satisfy the stated redemptions on first class of securities 22, the issuer will set up an additional pool of preferred stock 26 and purchase preferred stock securities 20 for this additional pool of preferred stock 26 in an amount sufficient to overcome any shortfalls in dividends or in redemption proceeds. Any proceeds from preferred stock securities 20 in the additional pool of preferred stock 26 that remain after covering any shortfalls will belong to the issuer's account 27 and will be passed through to the issuer's account 27. FIG. 6B is a flowchart showing an example of the structure that I have shown in FIG. 6A In this example, the issuer raises $100 million of capital and uses that capital to purchase $100 million of preferred stock securities 20. This $100 million of capital is raised by offering first class of securities 22 with stated redemptions of $100 million at the end of 7 years and stated dividend rate of 5%. The issuer uses these proceeds of $100 million to purchase $100 million worth of preferred stock securities 20, with a weighted average dividend of 6% and a weighted average redemption of 7 years. These preferred stock securities 20 are deposited into the pool of preferred stock 21 that backs these first class of securities 22. Immediately thereafter, $36 million of preferred stock securities 20 are assumed to default and are assumed to pay zero dividends and zero redemption proceeds. The remaining $64 million of preferred stock securities 20 are assumed to generate annual dividend of 6% and are also assumed to generate redemption proceeds of $64 million. To cover any shortfall of dividends or redemption proceeds to holders of first class of securities 22, the issuer sets up an additional pool of preferred stock 26 and purchases $36 million of preferred stock securities 20 with a weighted average dividend of 6% and a weighted average redemption of 7 years. In the first year dividends on the pool of preferred stock 21 are 6% of the $64 million outstanding preferred stock securities 20, or $3.84 million. In the first year dividends on the additional pool of preferred stock 26 are 6% of the $36 million outstanding preferred stock securities 20, or $2.16 million. Dividends are allocated as follows:

1) Used each year to pay the 5% stated dividend rate on first class of securities 22. In the first year, when $100 million of first class of securities 22 are outstanding, this is equal to $5 million. However; the dividend amount from the pool of preferred stock 21 still remaining at this point is only $3.84 million, so the issuer covers the shortfall by passing through $1.16 of dividends from the additional pool of preferred stock 26.

2) Any dividend amount still remaining is passed through to the issuer's account 27. In the first year, no dividends remain from the pool of preferred stock 21, and the $1 million remaining dividends from the additional pool of preferred stock 26 are passed through to the issuer's account 27.

Over the life of the pool of preferred stock 21, the pool of preferred stock 21 is assumed to generate redemption proceeds of $64 million, and the additional pool of preferred stock 26 is assumed to generate redemption proceeds of $36 million, which are allocated as follows:

1) Used to make $100 million of stated redemptions on first class of securities 22. However, redemption proceeds from the pool of preferred stock 21 remaining at this point are only $64 million, so the issuer covers the shortfall by passing through the entire $36 million of redemption proceeds from the additional pool of preferred stock 26.

2) Any remainder from the pool of preferred stock 21 or the additional pool of preferred stock 26 is passed through to the issuer's account 27. In this example, the entire redemption proceeds from both the pool of preferred stock 21 and the additional pool of preferred stock 26 have been disbursed at this point, so there is no payment made.

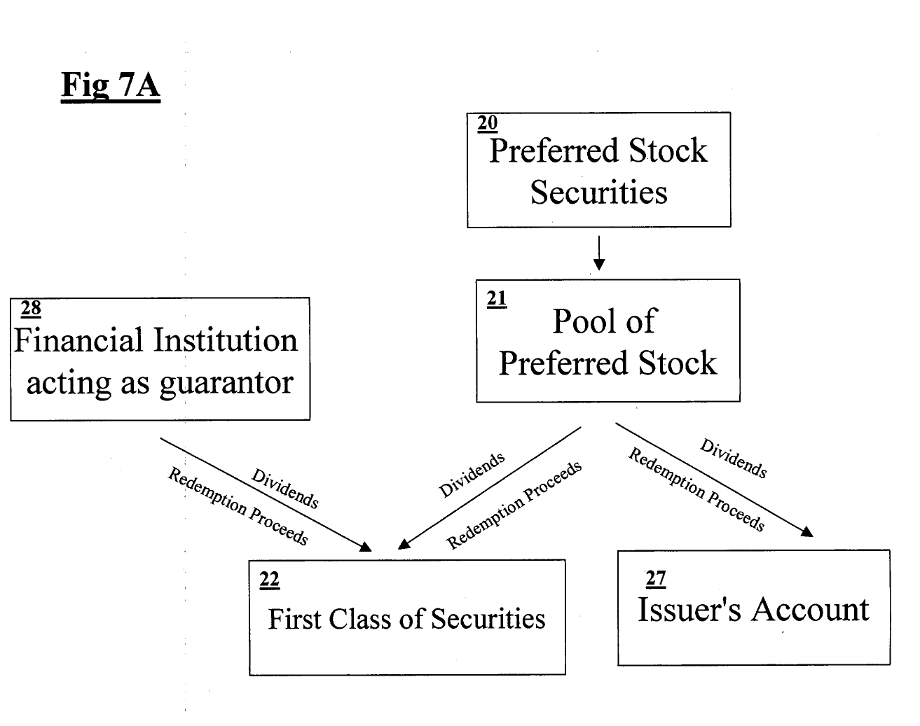

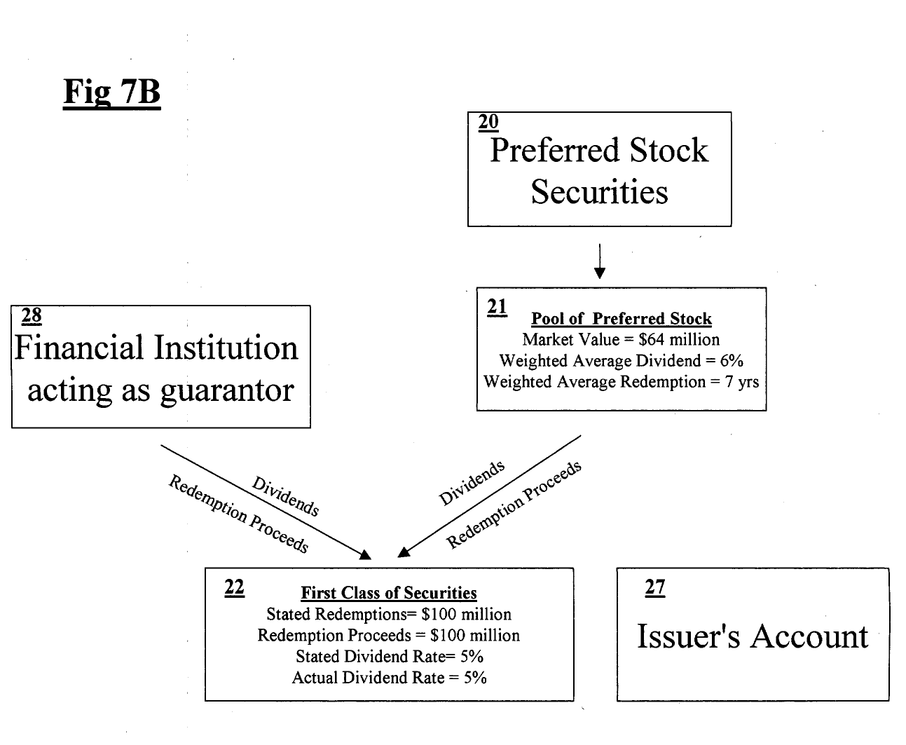

Description of FIGS. 7A and 7B:

FIG. 7A is a flowchart in which the issuer arranges for the issuance of a single class of securities termed first class of securities 22, which is backed by a pool of preferred stock 21. The first class of securities 22 has a stated dividend rate and stated redemptions. Dividends from the pool of preferred stock 21 are passed through to the holders of these securities to the extent that dividends do not exceed the stated dividend rate, and any redemption proceeds from that pool of preferred stock 21 are passed through to the holders of these securities to the extent that redemption proceeds do not exceed the stated redemptions. Any amounts not passed through to security holders will belong to the issuer's account 27 and will be passed through to the issuer's account 27. The issuer arranges for and purchases a guarantee from a financial institution 28 that in the event the pool of preferred stock 21 does not generate dividends sufficient to satisfy the stated dividend rate on first class of securities 22, or generate redemption proceeds sufficient to satisfy the stated redemptions on first class of securities 22, the financial institution 28 will pass through payments of preferred stock dividends and preferred stock redemptions to holders of first class of securities 22 in an amount sufficient to overcome any shortfall.

FIG. 7B is a flowchart showing an example of the structure that I shown in FIG. 7A. In this example, the issuer raises $100 million of capital and uses that capital to purchase $100 million of preferred stock securities 20. This $100 million of capital is raised by offering first class of securities 22 with stated redemptions of $100 million at the end of 7 years and stated dividend rate of 5%. The issuer uses these proceeds of $100 million to purchase $100 million worth of preferred stock securities 20, with a weighted average dividend of 6% and a weighted average redemption of 7 years. These preferred stock securities 20 are deposited into the pool of preferred stock 21 that backs these first class of securities 22. To cover any shortfall of dividends or stated redemptions on first class of securities 22, the issuer has purchased a guarantee from a financial institution 28 under which the financial institution will pass through preferred stock dividends and redemptions sufficient to cover any shortfall. Immediately thereafter, $36 million of preferred stock securities 20 are assumed to default and are assumed to pay zero dividends and zero redemption proceeds. The remaining $64 million of preferred stock securities 20 are assumed to generate annual dividends of 6% and are also assumed to generate redemption proceeds of $64 million. To cover any shortfall of dividends or stated redemptions on first class of securities 22, the financial institution 28 that serves as guarantor passes through the shortfall that arises because of this default.

In the first year dividends on the pool of preferred stock 21 are 6% of the $64 million outstanding preferred stock securities 20, or $3.84 million. Dividends are used each year to pay the 5% stated dividend rate on first class of securities 22. In the first year, when $100 million of first class of securities 22 are outstanding, this is equal to $5 million. However, the dividend amount from the pool of preferred stock 21 still remaining at this point is only $3.84 million, so the financial institution 28 that serves as guarantor covers the shortfall by passing through $1.16 million of dividends from preferred stock securities 20 that it owns. In this example, there are no remaining dividends from the pool of preferred stock 21 so no payment is made to the issuer's account 27.

Over the life of the pool of preferred stock 21, the pool of preferred stock 21 is assumed to generate redemption proceeds of $64 million, which are used to make $100 million of stated redemptions on first class of securities 22. However, the redemption proceeds from the pool of preferred stock 21 remaining at this point are only $64 million, so the financial institution 28 that serves as guarantor passes through $36 million of redemption proceeds from preferred stock securities that it owns to make up for this shortfall. Any remainder from the pool of preferred stock 21 is paid to the issuer's account 27. In this example, the entire $64 million has been disbursed at this point, so there is no payment made to the issuer's account 27.

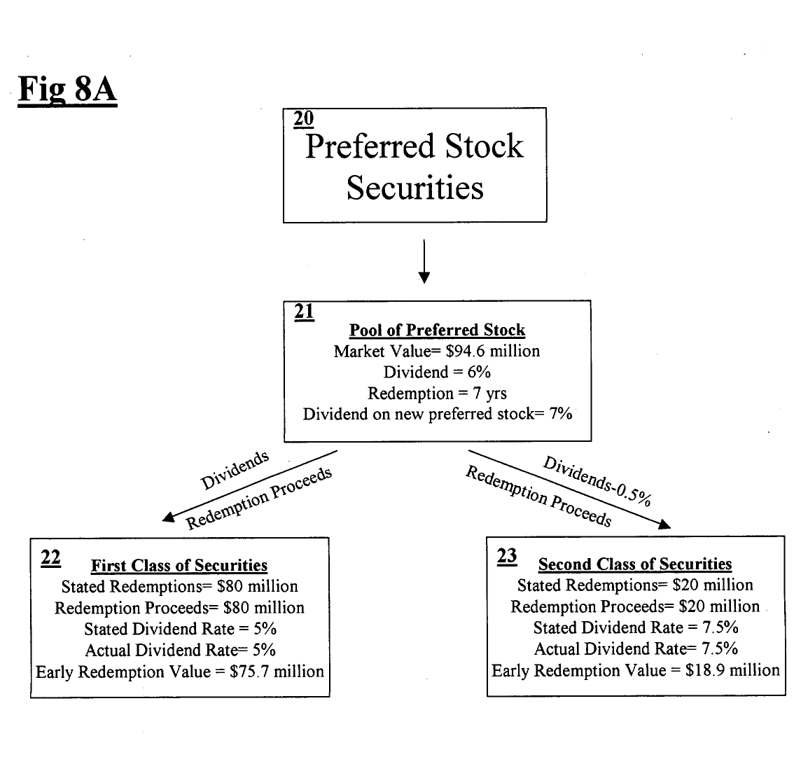

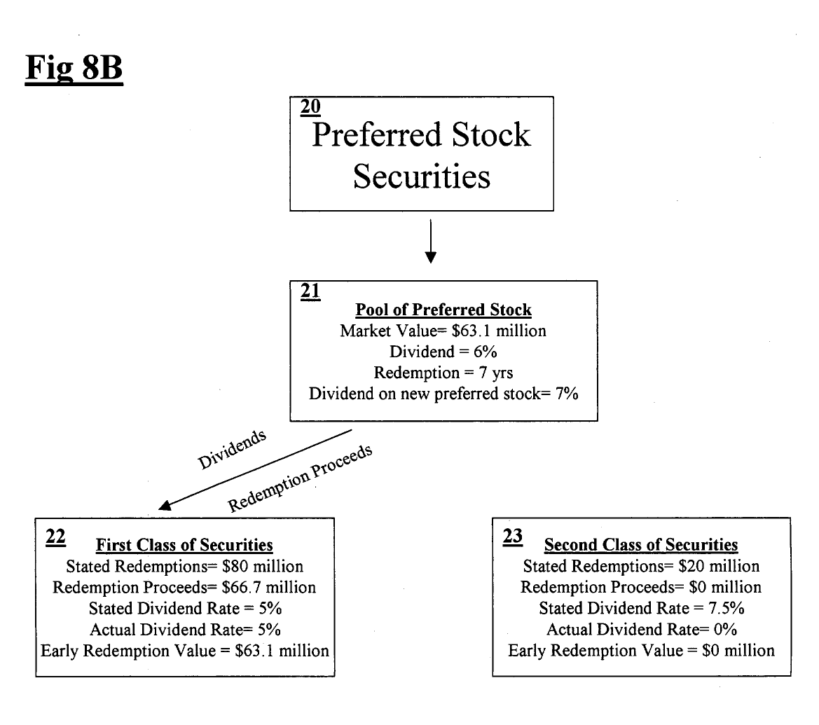

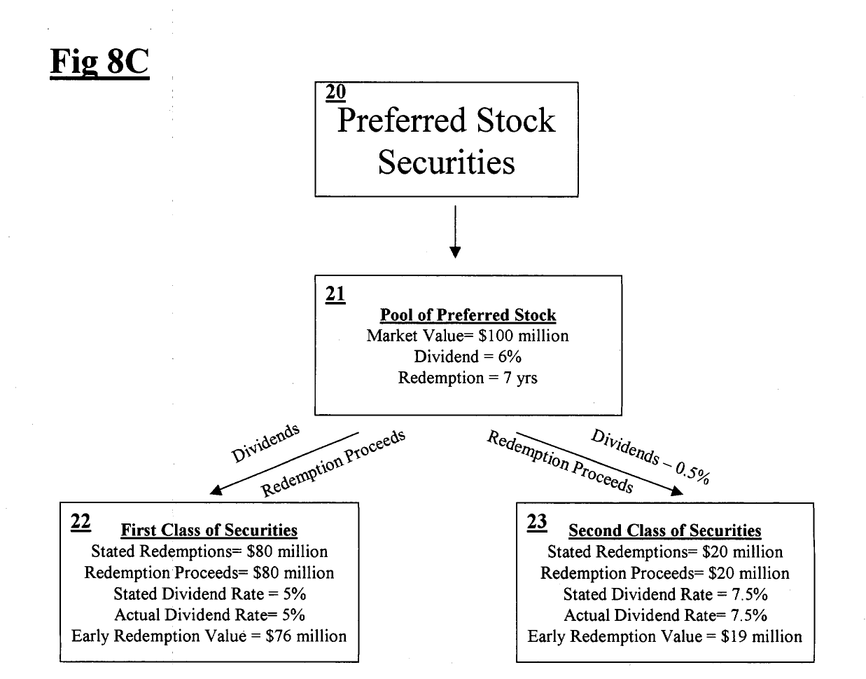

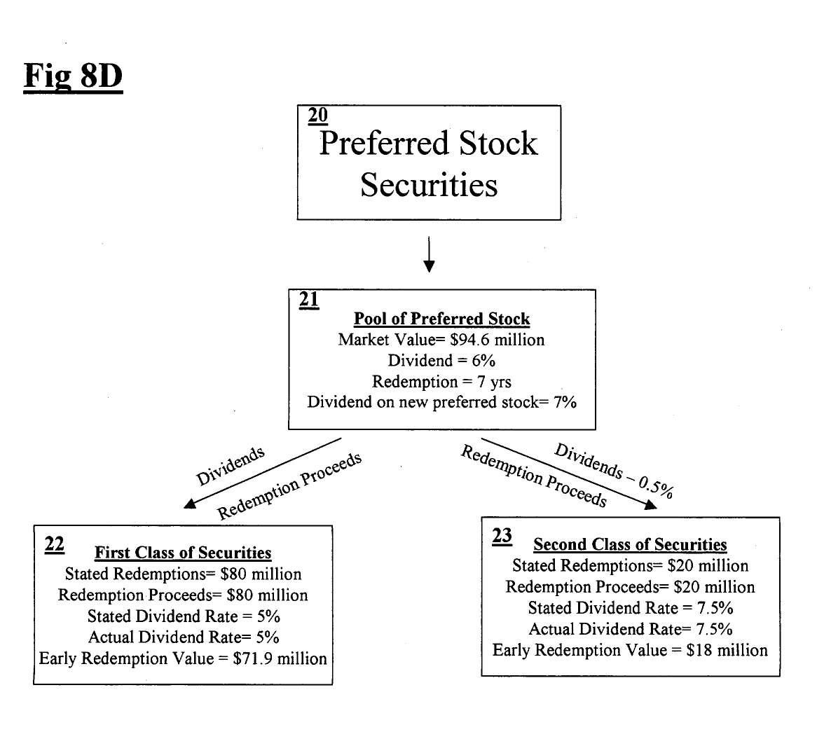

Description of FIGS. 8A, 8B, 8C and 8D:

FIG. 8A is a flowchart showing the early redemption privilege, with an adjustment to reflect change in market value of the pool of preferred stock 21. It expands on the structure shown in FIG. 2A, in which the issuer arranges for the issuance of two classes of securities: first class of securities 22 and second class of securities, both of which are backed by a pool of preferred stock 21. Each class of security has a stated dividend rate and has stated redemptions, but the second class of securities 23 is only paid dividends and redemption proceeds after payments have been made on the first class of securities 22 and after the issuer's fees and charges have been paid. Stated redemption for both the first and second classes of securities is at the end of 7 years, and both the-first and second classes of securities permit early redemption of all or part of this stated redemption with an adjustment to reflect change in market value of the pool of preferred stock 21. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a dividend of 6% and a redemption date at the end of 7 years. These preferred stock securities 20 are deposited into the pool of preferred stock 21 that backs both the first and second classes of securities. Over the life of the pool of preferred stock 21, the preferred stock securities 20 are assumed to generate annual dividends of 6% and are also assumed to generate redemption proceeds of $100 million. There are no redemption charges. The early redemption values of both the first and second classes of securities are calculated as follows:

Early redemption value of second class of securities=(Market value of pool of preferred stock+Original value of defaulted preferred stock)×Original value of second class of securities currently outstanding/Original value of pool of preferred stock−Original value of defaulted preferred stock, but not less than zero

Early redemption value of first class of securities=Market value of pool of preferred stock−early redemption value of second class of securities

Immediately after issue, dividends on new preferred stock securities with a 7 year redemption period increase from 6% to 7%. Therefore the market value of the pool of preferred stock 21 declines to:

100,000,000/1.07\hat{ }7+6,000,000×a7

where a7 is the present value of an annuity immediate of $1 per annum for 7 years, and equals 5.39 at 7%

so the market value of the pool of preferred stock 21 declines from $100 million to $94.6 million.

As a result of this change in market value of the pool of preferred stock 21, the early redemption values of the first and second classes of securities become:

Early redemption value of second class of securities=($94.6 million+$0 million)×$20 million/$100 million−$0 million, or $18.9 million

Early redemption value of first class of securities=$94.6 million−$18.9 million=$75.7 million

FIG. 8B shows the impact of preferred stock defaults on early redemption values. It assumes that one-third of preferred stock securities 20 in the pool of preferred stock 21 default and pay no dividends or redemption proceeds. Therefore the market value of the pool of preferred stock 21 declines by $31.5 million, from $94.6 million to $63.1 million. As a result of this change in market value of the pool of preferred stock 21, the early redemption values of the first and second classes of securities as shown in FIG. 8B become:

Early redemption value of second class of securities=($63.1 million+$33.3 million)×$20 million/$100 million−$33.3 million=−$14.0 million. Since the value of second class of securities cannot be less than zero, the value of second class of securities 23 equals zero.

Early redemption value of first class of securities=$63.1 million−$0 million=$63.1 million

Note that despite the default, the remaining two-thirds of preferred stock securities 20 in the pool of preferred stock 21 generate redemption proceeds of $66.7 million over the life of the pool of preferred stock 21, all of which are paid to first class of securities 22. They also generate dividends of 6% that are used each year toward paying the 5% stated dividend rate on first class of securities 22. In the first year dividends on the pool of preferred stock 21 are 6% of the $66.7 million outstanding preferred stock securities 20, or $4 million, which is exactly equal to the stated dividend on first class of securities 22.

FIG. 8C is a flowchart showing the early redemption privilege, with an adjustment for the redemption charge. It expands on the structure shown in FIG. 2A, in which the issuer arranges for the issuance of two classes of securities: first class of securities 22 and second class of securities, both of which are backed by a pool of preferred stock 21. Each class of security has a stated dividend rate and has stated redemptions, but the second class of securities 23 are only paid dividends and redemption proceeds after payments have been made on the first class of securities 22 and after the issuer's fees and charges have been paid. Stated redemption for both the first and second classes of securities is at the end of 7 years, and both the first and second classes of securities permit early redemption of all or part of this stated redemption with an adjustment for a redemption charge that is assessed as a percent of the original value of first and second classes of securities currently outstanding. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a dividend of 6% and a redemption date at the end of 7 years. These preferred stock securities 20 are deposited into the pool of preferred stock 21 that backs both the first and second classes of securities. Over the life of the pool of preferred stock 21, the preferred stock securities 20 are assumed to generate annual dividends of 6% and are also assumed to generate redemption proceeds of $100 million. The early redemption values of both the first and second classes of securities are calculated as follows:

Early redemption value of second class of securities=Original value of second class of securities currently outstanding×(100%−Redemption charge percent)

Early redemption value of first class of securities=Original value of first class of securities currently outstanding×(100%−Redemption charge percent)

Assuming that the redemption charge is currently 5%, the early redemption values of the first and second classes of securities become:

Early redemption value of second class of securities=$20 million×(100%−5%), or $19 million

Early redemption value of first class of securities=$80 million×(100%−5%), or $76 million

FIG. 8D is a flowchart that expands on the early redemption privilege shown in FIG. 8A, with an adjustment to reflect change in market value of the pool of preferred stock 21 as well as an adjustment for the redemption charge. It starts with the situation illustrated in FIG. 8A, where the early redemption values for second and first classes of securities are $18.9 million and $75.7 million respectively. Assuming that the redemption charge is 5%, the early redemption values of the first and second classes of securities become:

Early redemption value of second class of securities=$18.9 million×(100%−5%), or $18 million

Early redemption value of first class of securities=$75.7 million×(100%−5%), or $71.9 million

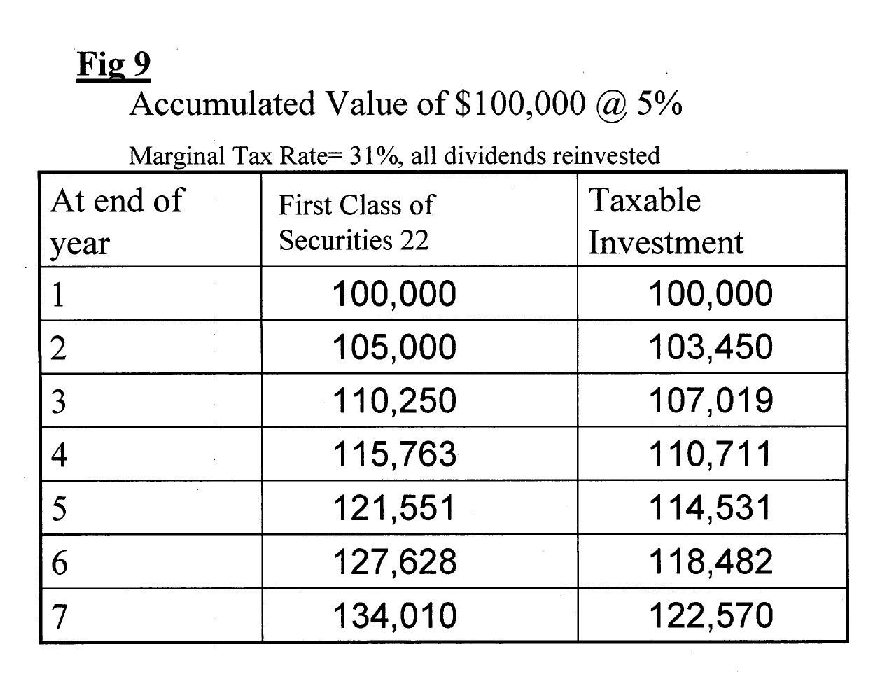

Description of FIG. 9:

FIG. 9 is a table that compares the accumulated value of first class of securities 22 at their stated dividend rate with the after-tax accumulated value of a taxable investment. The after-tax accumulated value of this taxable investment is calculated using the formula:

Amount invested×{(1+guaranteed rate×(1−marginal tax rate))}\hat{ }n

The accumulated value of first class of securities 22 at their stated dividend rate is calculated using the formula:

Amount invested×(1+stated dividend rate)\hat{ }n

where n is the number of whole years at the end of which the comparison is made.

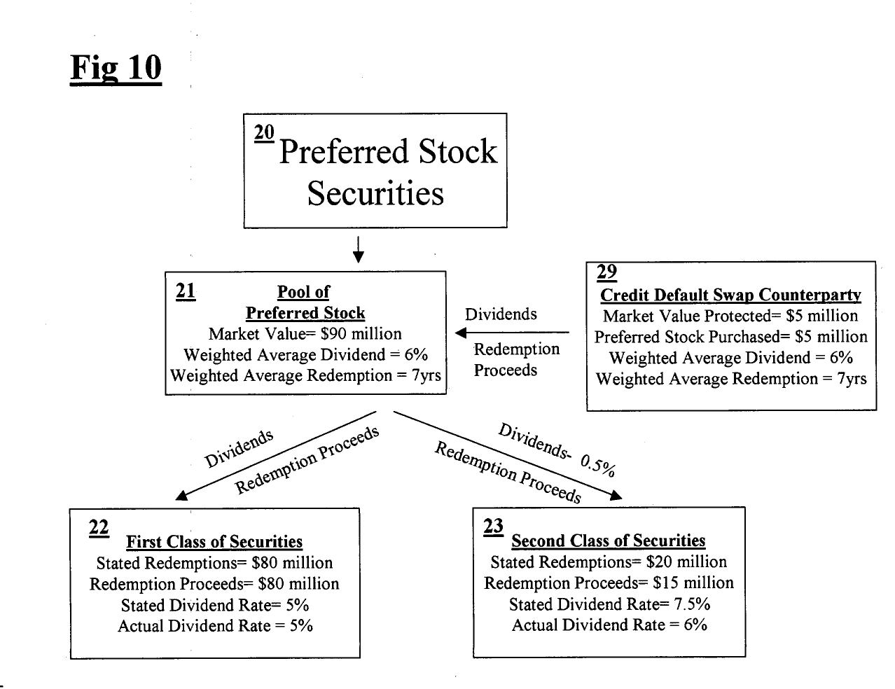

Description of FIG. 10:

FIG. 10 is a flowchart that shows the issuance of two classes of securities, together with the purchase of credit derivatives. It expands on the structure shown in FIG. 2A, in which the issuer arranges for the issuance of two classes of securities: first class of securities 22 and second class of securities 23, both of which are backed by a pool of preferred stock 21. Each class of security has a stated dividend rate and stated redemptions, but the second class of securities 23 are only paid dividends and redemption proceeds after payments have been made on the first class of securities 22 and after the issuer's fees and charges have been paid. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a dividend of 6% and a redemption date at the end of 7 years. These preferred stock securities 20 are deposited into the pool of preferred stock 21 that backs both the first and second classes of securities. To partly offset any decline in the value of the pool of preferred stock 21 as a result of default on some of the preferred stocks in the pool of preferred stock 21, the issuer enters into a credit default swap with a counterparty 29 under which the counterparty covers the cost of any default of up to 5% of the value of the pool of preferred stock 21, for which the issuer pays the counterparty a portion of the fees and charges it expects to collect. Now assume that one-tenth of the preferred stock securities 20 in the pool of preferred stock 21 default and pay no dividends or redemption proceeds. Therefore the value of the pool of preferred stock 21 declines by $10 million, from $100 million to $90 million. To partly offset this decline in the value of the pool of preferred stock 21, the counterparty 29 makes payments in preferred stock dividends and redemptions to the pool of preferred stock 21 that cover the cost of default of 5% of the value of the pool of preferred stock 21. The pool of preferred stock 21 passes through these additional dividends and redemption proceeds to first and second classes of securities, offsetting a portion of the dividends and redemption proceeds that were lost due to the default. Without the credit default swap, the second class of securities 23 would receive only $0.9 million of dividends in the first year (which is 6% of the $90 million of remaining preferred stock, less $4 million of stated dividends to first class of securities 22, less fees and charges of $0.5 million). The credit default swap provides extra dividends of 6% on the $5 million of market value protected, which equals $0.3 million in the first year, so the actual dividend rate on second class of securities 23 in the first year is $1.2 million divided by $20 million, or 6%. Likewise, the redemption proceeds paid to second class of securities 23 increase from $10 million to $15 million as a result of the credit default swap.

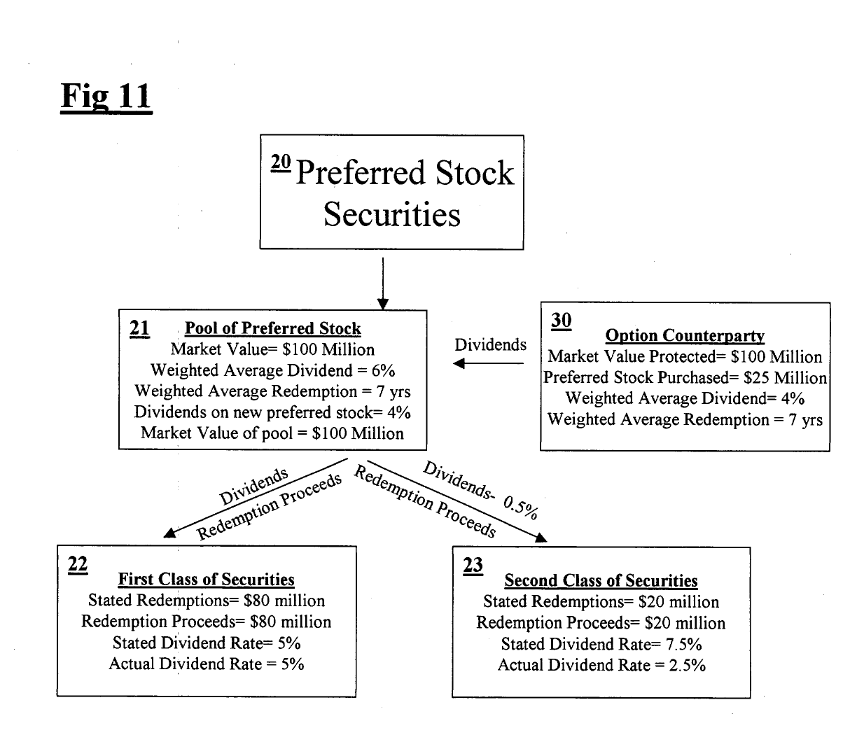

Description of FIG. 11:

FIG. 11 is a flowchart that shows the issuance of two classes of securities, together with a hedge against dividend rate risk. It expands on the structure shown in FIG. 2A, in which the issuer arranges for the issuance of two classes of securities: first class of securities 22 and second class of securities 23, both of which are backed by a pool of preferred stock 21.

Each class of security has a stated dividend rate and stated redemptions, but the second class of securities 23 are only paid dividends and redemption proceeds after payments have been made on the first class of securities 22 and after the issuer's fees and charges have been paid. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a dividend of 6% and a redemption date at the end of 7 years. These preferred stock securities 20 are deposited into the pool of preferred stock 21 that backs both the first and second classes of securities. To partly offset any loss of dividends that may result if dividend rates decline in the future causing preferred stock securities 20 to be redeemed earlier than anticipated, the issuer purchases an option on preferred stock from an option counterparty 30 under which the option counterparty 30 will cover the shortfall in preferred stock dividends in the event that dividends on new preferred stock securities fall below 5%, and the issuer pays the option counterparty 30 a portion of the fees and charges it expects to collect. Now assume that the dividend rate on new preferred stock securities falls from 6% to 4%, as a result of which all preferred stock securities 20 in the pool of preferred stock 21 are redeemed for $100 million. The $100 million received as a result of this redemption will be used to purchase new preferred stock securities 20 for the pool of preferred stock 21, with a dividend rate of 4%. To partly offset this decline in dividends on the pool of preferred stock 21, the option counterparty 30 will make payments in preferred stock dividends to the pool of preferred stock 21 that will equal the difference between the a dividend rate of 5% and the new dividend rate of 4%, hence it will purchase preferred stock securities and pass through a dividend amount from those preferred stock securities equal to 1% of the value of the pool of preferred stock 21. The pool of preferred stock 21 passes through this dividend to holders of the first and second classes of securities, offsetting a portion of the dividends that were lost as a result of falling dividend rates causing preferred stock securities 20 to be redeemed earlier than anticipated. Had the option not been purchased, the second class of securities 23 would have received no dividend in the first year (because the 4% dividend on $100 million of preferred stock would only pay the $4 million of stated dividends to first class of securities 22, and would not even pay the fees and charges of $0.5 million). The purchase of the option provides extra dividend of 1% on the $100 million of market value protected, which equals $1 million in the first year, so the actual dividend rate on second class of securities 23 in the first year is $0.5 million divided by $20 million, or 2.5%.

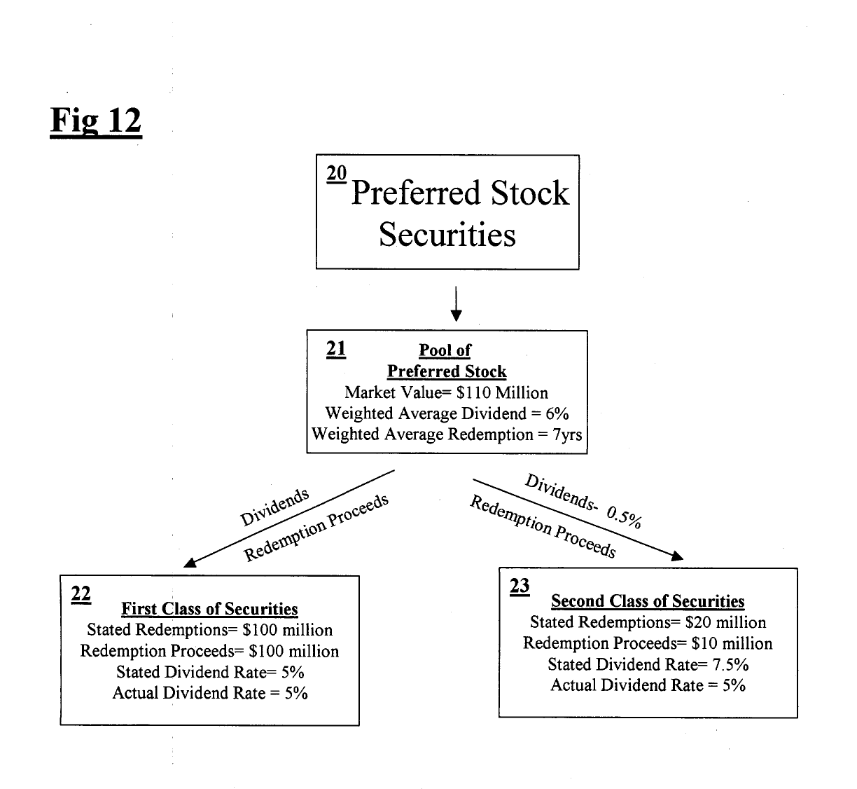

Description of FIG. 12:

The security holder may be given the right for a period of time to invest certain additional amounts into the pool of preferred stock 21. If the security holder submits additional amounts for investment, those amounts will be invested in the pool of preferred stock 21 where they will accrue dividends for the benefit of the security holder.

FIG. 12 is a flowchart that shows the right to invest additional amounts. It expands on the structure shown in FIG. 2A, in which the issuer arranges for the issuance of two classes of securities: first class of securities 22 and second class of securities 23, both of which are backed by a pool of preferred stock 21. Each class of security has a stated dividend rate and stated redemptions, but the second class of securities 23 are only paid dividends and redemption proceeds after payments have been made on the first class of securities 22 and after the issuer's fees and charges have been paid. In this example, the issuer raises $100 million of capital and uses that capital to purchase $100 million of preferred stock securities 20. This $100 million of capital is raised by offering first class of securities 22 with stated redemptions of $80 million at the end of 7 years and stated dividend rate of 5%, and second class of securities 23 with stated redemptions of $20 million at the end of 7 years and stated dividend rate of 7.5%. The issuer uses these proceeds of $100 million to purchase $100 million worth of preferred stock securities 20, with a dividend of 6% and a redemption date at the end of 7 years. These preferred stock securities 20 are deposited into the pool of preferred stock 21 that backs both the first and second classes of securities. Immediately thereafter, $10 million of preferred stock securities 20 are assumed to default and are assumed to pay zero dividends and zero redemption proceeds. The remaining $90 of preferred stock securities 20 are assumed to generate annual dividends of 6% and are also assumed to generate redemption proceeds of $90 million. Assume that immediately thereafter, holders of first class of securities 22 invest an additional $20 million. This amount goes into the pool of preferred stock 21 where it is used to purchase $20 million of preferred stock securities 20 with a dividend of 6% and a redemption date at the end of 7 years, due to which the market value of preferred stock securities in the pool of preferred stock 21 increases from $90 million to $110 million. In the first year dividends on the pool of preferred stock 21 are 6% of the $110 million outstanding preferred stock securities 20, or $6.6 million. Dividends are allocated as follows:

1) Used each year to pay the 5% stated dividend rate on first class of securities 22. In the first year, when $100 million of first class of securities 22 are outstanding, this is equal to $5 million

2) Any amount still remaining is used to pay the issuer's fees and charges which are equal to 0.5% of first and second classes of securities outstanding. In the first year, when $100 million of first and $20 million of second class of securities are outstanding, this is equal to $0.6 million

3) Any amount still remaining is used to pay the 7.5% stated dividend rate on second class of securities 23. In the first year, when $20 million of second class of securities 23 are outstanding, this is equal to $1.5 million. However, the dividend amount still remaining at this point is only $1 million, so the actual dividend rate paid to holders of second class of securities 23 is $1 million divided by $20 million, which equals 5%

4) Any remainder is paid to holders of second class of securities 23. In this example, the entire amount has been disbursed at this point, so there is no payment made.

Over the life of the pool of preferred stock 21, the preferred stock securities 20 are assumed to generate redemption proceeds of $110 million, which are allocated as follows:

1) Used to make $100 million of stated redemptions on first class of securities 22.

2) Any amount still remaining is used to make $20 million of stated redemptions on second class of securities 23. However, the redemption proceeds remaining at this point are only $10 million, so the holders of second class of securities 23 only receive half their stated redemptions of $20 million.

3) Any remainder is paid to holders of second class of securities 23. In this example, the entire $110 million has been disbursed at this point, so there is no payment made.

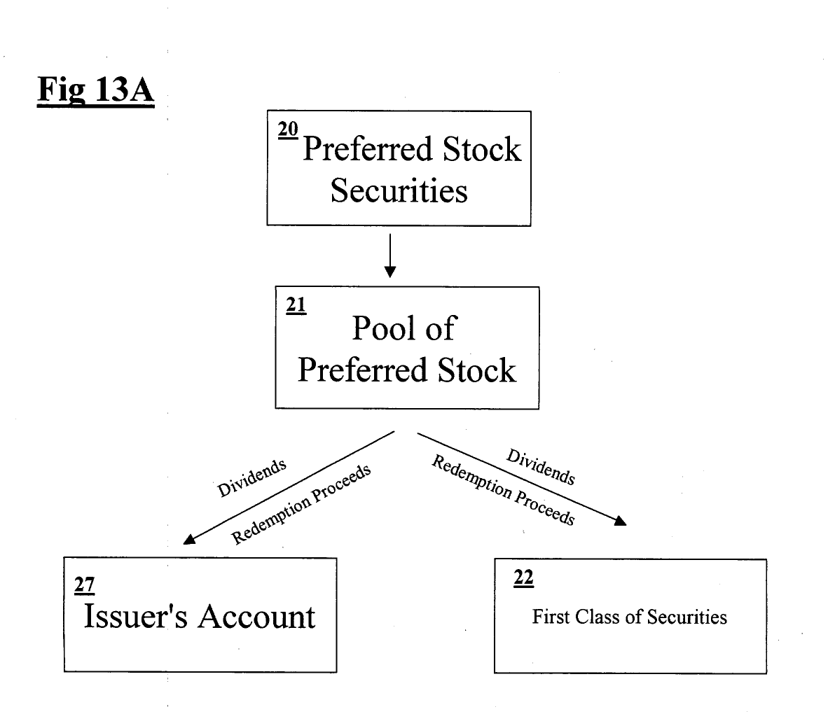

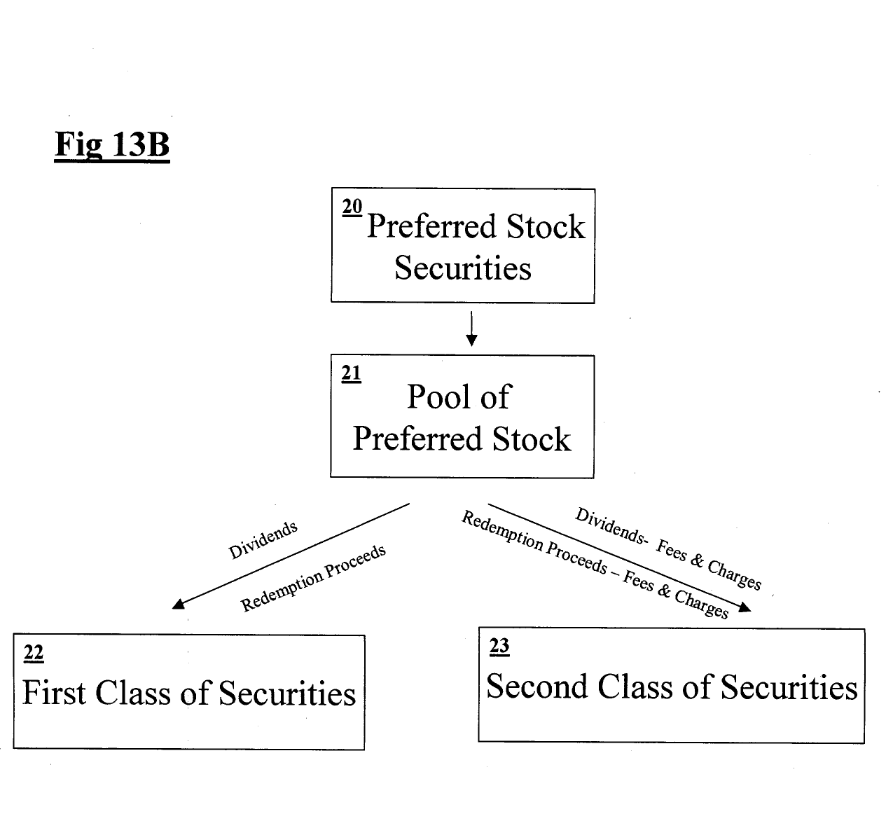

Description of FIGS. 13A and 13B:

FIGS. 13A and 13B are flowcharts showing an example of the creation of additional classes of securities. It begins with the structure shown in FIG. 13A, in which the issuer arranges for the issuance of a single class of securities termed first class of securities 22, which are backed by a pool of preferred stock 21. This first class of securities 22 has a stated dividend rate and stated redemptions. Dividends from the pool of preferred stock 21 are passed through to the holders of these securities to the extent that dividends do not exceed the stated dividend rate, and any redemption proceeds from that pool of preferred stock 21 are passed through to the holders of these securities to the extent that redemption proceeds do not exceed the stated redemptions. Any amounts not passed through to security holders will belong to the issuer's account 27 and will be passed through to the issuer's account. Immediately thereafter, the issuer creates a second class of securities. As a consequence of issuance of this second class of securities 23, the structure shifts to that shown in FIG. 13B. All or part of the proceeds from issuing this second class of securities 23 are assumed by the issuer as compensation for loss of future revenue from the pool of preferred stock 21. The remainder of the proceeds from issuing this second class of securities 23 are invested in the pool of preferred stock 21. Each class of security has a stated dividend rate and stated redemptions, but the second class of securities 23 is only paid dividends and redemption proceeds after payments have been made on first class of securities 22 and after the issuer's fees and charges have been paid. In the event that the pool of preferred stock 21 does not generate dividends sufficient to satisfy the dividend rate on both the first and second classes of securities as well as to pay the issuer's fees and charges, the holders of second class of securities 23 will not be paid their stated dividend rate. Similarly, in the event that the pool of preferred stock 21 does not generate redemption proceeds sufficient to satisfy the stated redemptions on both the first and second classes of securities as well as to pay the issuer's fees and charges, the holders of second class of securities 23 will not be paid their stated redemptions. Conversely, in the event that the pool of preferred stock 21 generated dividends that are more than sufficient to satisfy the stated dividend rate on both the first and second classes of securities as well as to pay the issuer's fees and charges, the holders of second class of securities 23 will be paid the excess dividends. Similarly, in the event that the pool of preferred stock 21 generates redemptions that are more than sufficient to satisfy the stated redemptions on both the first and second classes of securities as well as to pay the issuer's fees and charges, the holders of second class of securities 23 will be paid these excess redemptions.

The aspects of this invention that are not supported with drawings are described as follows:

Selection and Rebalancing of Preferred Stock:

The selection and rebalancing of preferred stock to match the cash-flow characteristics of the various classes of securities is accomplished as follows:

The weighted average redemption of preferred stock securities in the pool of preferred stock is equal to the stated redemptions of the various classes of securities created by this securitization method.

Preferred stock securities in the pool of preferred stock are not callable or redeemable by the corporations that issued them earlier than the stated redemptions on the various classes of securities created by this securitization method.

Disregarding any credit defaults, the weighted average dividend of preferred stock securities in the pool of preferred stock is at least sufficient to support the stated dividend rate on the various classes of securities created by this securitization method.

Right to Reinvest Dividends:

The security holder may be given the right to reinvest for a period of time any dividends received from the pool of preferred stock. The security holder will specify whether or not a dividend is to be reinvested, before the date on which that dividend is received. If the security holder requests reinvestment, then that dividend will not be paid in cash, but instead it will be reinvested in the pool of preferred stock where it will accrue further dividends for the benefit of the security holder.

Right to Reinvest Redemption Proceeds:

The security holder may be given the right to reinvest for a period of time any redemption proceeds received from the pool of preferred stock. The security holder will specify whether or not redemption proceeds are to be reinvested, before the date on which those redemption proceeds are received. If the security holder requests reinvestment, then those redemption proceeds will not be paid in cash, but instead they will be reinvested in the pool of preferred stock where they will accrue dividends for the benefit of the security holder.

Issuance of Additional Securities:

The issuer may issue additional securities within each class from time to time. The proceeds raised from issuing additional securities within each class will be invested in the pool of preferred stock.

Trading on Secondary Market:

The issuer may allow securities created by this securitization process to be traded on a secondary market. This secondary market may be an exchange (such as a stock exchange or commodity exchange), a trading network (such as an inter-bank market), or a syndicate or other group of traders that buys and sells these securities. The trading mechanism may employ brokers and dealers, where brokers receive trades and direct them to dealers that make a market in the security. The trading mechanism will employ a means for price discovery, such as open auction or Dutch auction, and will require that trades be settled according to a settlement procedure.

Assignment of Credit Rating:

The issuer may allow one or more classes of securities created by this securitization process to be assigned a credit rating by a rating agency. The process for applying for and obtaining a credit rating varies for various rating agencies.

Enhancement of Early Redemption Value:

On the occurrence of a specified event to the security holder, the issuer may enhance the early redemption value. The specified event may be one or more of the following: death of the security holder, disability of the security holder, confinement of the security holder in a nursing home, a diagnosis that the security holder is terminally ill, or a diagnosis that the security holder suffers from a specified critical illness. Critical illness is any illness that causes a siginificant impairment of the physical or mental health of the security holder. The issuer may limit the enhancement of early redemption value only to specified events that occur at certain times, or that originate after the issuance of the security. For instance, the enhancement of early redemption value may be conditioned on death of the security holder occuring at least 12 months after issuance of the security, or on the diagnosis of critical illness that originated after issuance of the security. The issuer may require proof regarding the occurrence of the specified event. The enhanced early redemption value will be paid to the security holder or to his representative, where representative may be his beneficiary, heir, estate, guardian, assignee, nominee or authorized agent.

Conclusion, Ramifications and Scope:

This securitization method will benefit the security holder by providing the federal income tax benefits of dividends under proposed tax law and by allowing potential security holders to invest in securities that meet their particular risk and return criteria, and will benefit the issuer by creating a source of future revenue.

While my above description contains many specificities, these should not be construed as limitations on the scope of the invention, but rather as an exemplification of one possible example thereof Many other variations are possible. For example, a variation may be the creation of securities with a stated dividend rate that varies based on economic conditions. An example of such a security would be with a dividend rate that is set for a period of one year after issue and thereafter is adjusted annually based on change in dividend yield on the S&P 500 index.

Accordingly, the scope of the invention should not be limited by the embodiment(s) illustrated, but encompassed by the appended claims and their legal equivalents.

I claim:

1. A method for creating new securities from underlying securities, comprising the steps of:
(a) creating at least one class of securities backed by a pool of preferred stock, with each class having a stated dividend rate and stated redemptions, with different classes of said securities having differing degrees of probability that said stated dividend rate and said stated redemptions will actually be paid
(b) creating a plurality of securities within each said class
(c) conveying at least a portion of any dividends and at least a portion of any redemption proceeds from said pool of preferred stock to said securities for a period of time
whereby tax advantages of preferred stock dividends are provided to holders of said securities.

2. The method of claim 1 in which two classes of securities are created, further comprising the steps of:
(a) allocating dividends from said pool of preferred stock so that any dividends from said pool of preferred stock are passed through to second class of securities only to the extent that said dividends still remain after paying said stated dividend rate on first class of securities and after paying for fees and charges of the issuer
(b) allocating redemption proceeds from said pool of preferred stock so that any redemption proceeds from said pool of preferred stock are passed through to said second class of securities only to the extent that said redemption proceeds still remain after paying said stated redemptions on said first class of securities and after paying for fees and charges of said issuer.

3. The method of claim 2, further comprising the step of guaranteeing that any shortfall in paying said stated dividend rate on said first class of securities, and any shortfall in paying said stated redemptions on said first class of securities, will be met by said issuer of the first and second classes of securities by setting up an additional pool of preferred stock and purchasing preferred stock for said additional pool of preferred stock in an amount sufficient to overcome the shortfalls, with any remaining amount in said additional pool of preferred stock being passed through to said issuer.

4. The method of claim 2, further comprising the step of guaranteeing that any shortfall in paying said stated dividend rate on said first class of securities, and any shortfall in paying said stated redemptions on said first class of securities, will be met by the issuer of the first and second classes of securities by purchasing a guarantee from a financial institution whereby said financial institution will provide payments of preferred stock dividends and preferred stock redemption proceeds to said first class of securities in an amount sufficient to overcome the shortfalls.

5. The method of claim 1 in which a single class of securities is created, further comprising the steps of:
(a) allocating dividends from said pool of preferred stock so that any dividends from said pool of preferred stock are passed through to said securities up to said stated dividend rate on said securities
(b) allocating redemption proceeds from said pool of preferred stock so that any redemption proceeds from preferred stock are passed through to said securities up to said stated redemptions on said securities
(c) allocating any remaining dividends and redemption proceeds by passing them through to the issuer of said securities.

6. The method of claim 5, further comprising the step of guaranteeing that any shortfall in paying said stated dividend rate on said securities, and any shortfall in paying said stated redemptions on said securities, will be met by the issuer of said securities by setting up an additional pool of preferred stock and purchasing preferred stock for said additional pool of preferred stock in an amount sufficient to overcome the shortfalls, with any remaining amount in said additional pool of preferred stock being passed through to said issuer.

7. The method of claim 5, further comprising the step of guaranteeing that any shortfall in paying said stated dividend rate on said securities, and any shortfall in paying said stated redemptions on said securities, will be met by the issuer of said securities by purchasing a guarantee from a financial institution whereby said financial institution will provide payments of preferred stock dividends and preferred stock redemption proceeds to said securities in an amount sufficient to overcome the shortfalls.

8. The method of claim 1, further comprising the step of granting to holders of said securities the right to redeem at least part of the security earlier than its stated redemptions, where said right to redeem may be subject to an adjustment selected from the group consisting of changes in market value and redemption charges.

9. The method of claim 1, further comprising the steps of:
(a) selecting preferred stock for said pool of preferred stock that matches the cash flow characteristics of the various classes of said securities
(b) rebalancing the composition of preferred stock in said pool of preferred stock to maintain cash flow match in the future
whereby the probability of receipt of dividends and redemption proceeds from said pool of preferred stock is increased.

10. The method of claim 1, further comprising the step of illustrating said stated dividend rate of said securities as compared to after tax return on competing investments.

11. The method of claim 1, further comprising the step of purchasing credit derivatives that at least partly offset any future reduction in dividends and in redemption proceeds from said pool of preferred stock in the event of deterioration in credit worthiness of preferred stock held by said pool of preferred stock.

12. The method of claim 1, further comprising the step of purchasing options that at least partly offset any future reduction in dividends from said pool of preferred stock in the event that dividend rates decline.

13. The method of claim 1, further comprising the step of granting to holders of said securities the right to invest certain additional amounts.

14. The method of claim 1, further comprising the step of creating additional classes of said securities from time to time.

15. The method of claim 1, further comprising the step of granting to holders of said securities the right to reinvest dividends.

16. The method of claim 1, further comprising the step of granting to holders of said securities the right to reinvest redemption proceeds.

17. The method of claim 1, further comprising the step of issuing additional securities within each class from time to time.

18. The method of claim 1, further comprising the step of allowing said securities to be traded on a secondary market.

19. The method of claim 1, further comprising the step of obtaining a credit rating on at least one class of said securities.

20. The method of claim 8, further comprising the step of enhancing the amount paid upon redemption of at least part of said security earlier than its stated redemptions, where such enhancement may be subject to the occurrence of an event to the holder of said security selected from the group consisting of death and disability and nursing home confinement and diagnosis of terminal illness and diagnosis of a specified critical illness.
